(19) United States
(12) Patent Application Publication
(10) Pub. No.: US 2009/0119484 A1
(43) Pub. Date: May 7, 2009

(54) Method and Apparatus for Implementing Digital Logic Circuitry

(76) Inventors: Stefan Mohl, Lund (SE); Pontus Borg, Lund (SE)

Correspondence Address: HARNESS, DICKEY & PIERCE, P.L.C., P.O. BOX 8910, RESTON, VA, 20195, US

(21) Appl. No.: 12/083,776

(22) PCT Filed: Oct. 18, 2006
(86) PCT No.: PCT/SE2006/001185

§ 371 Date: Sep. 23, 2008

Related U.S. Application Data
(60) Provisional application No. 60/727,454, filed on Oct. 18, 2005.
(60) Provisional application No. 60/727,457, filed on Oct. 18, 2005.
(60) Provisional application No. 60/727,456, filed on Oct. 18, 2005.
(60) Provisional application No. 60/727,452, filed on Oct. 18, 2005.

(51) Int. Cl. G06F 9/06

(52) U.S. Cl. 712/201; 712/E09.003

(57) ABSTRACT

A method of generating digital control parameters for implementing digital logic circuitry comprising functional nodes with at least one input or at least one output and connections indicating interconnections between said functional nodes, wherein said digital logic circuitry comprises a first path streamed by successive tokens, and a second path streamed by said tokens is disclosed. The method comprises determining a necessary relative throughput for data flow to said paths; assigning buffers to one of said paths to balance throughput of said paths; removing assigned buffers until said necessary relative throughput is obtained with minimized number of buffers; and generating digital control parameters for implementing said digital logic circuitry comprising said minimized number of buffers. An apparatus, a computer implemented digital logic circuitry, a Data Flow Machine, methods and computer program products are also disclosed.

### TECHNICAL FIELD

The present invention relates to improvement of digital logic circuitry. In particular, the invention relates to balancing relative throughput of data flow paths diverging in a first node and converging in a second node, with a suitable use of hardware area resources. The invention relates to apparatuses, methods and computer program products for carrying out the improvements.

### BACKGROUND OF THE INVENTION

Many different approaches towards easy-to-use programming languages for hardware descriptions have been employed in the recent years for providing a fast and easy way to design digital circuitry. When programming Data Flow Machines, a language different from the hardware descriptive language may be used. In principle, an algorithm description for performing a specific task on a Data Flow Machine only has to comprise the description itself, while an algorithm description which is to be executed directly in an integrated circuit must comprise many details of the specific implementation of the algorithm in hardware. For example, the hardware description must contain information regarding the placement of registers in order to provide optimum clock frequency, which multipliers to use, etc.

For many years, Data Flow Machines have been regarded as good models for parallel computing and consequently many attempts to design efficient Data Flow Machines have been performed. For various reasons, earlier attempts to design Data Flow Machines have produced poor results regarding computational performance compared to other available parallel computing techniques.

Note that a Data Flow Machine should not be confused with a data flow graph. When translating program source code, most compilers available today utilize data flow analysis and data flow descriptions (known as data flow graphs, or DFGs) in order to optimize the performance of the compiled program. A data flow analysis performed on an algorithm produces a data flow graph. The data flow graph illustrates data dependencies which are present within the algorithm. More specifically, a data flow graph normally comprises nodes indicating the specific operations that the algorithm performs on the data being processed, and arcs indicating the interconnection between nodes in the graph. The data flow graph is hence an abstract description of the specific algorithm and is used for analyzing the algorithm. On the other hand, a Data Flow Machine is a calculating machine which based on the data flow graph may actually execute the algorithm.

A Data Flow Machine operates in a radically different way compared to a control-flow apparatus, such as a von Neumann architecture (the normal processor in a personal computer is an example of a von Neumann architecture). In a Data Flow Machine the program is the data flow graph with special dataflow control nodes, rather than a series of operations to be performed by the processor. Data is organized in packets known as tokens that reside on the arcs of the data flow graph. A token can contain any data-structure that is to be operated on by the nodes connected by the arc, like a bit, a floating-point number, an array, etc. Depending on the type of Data Flow Machine, each arc may hold at the most either a single token (static Data Flow Machine) a fixed number of tokens (synchronous Data Flow Machine), or an indefinite number of tokens (dynamic Data Flow Machine).

The nodes in the Data Flow Machine wait for tokens to appear on a sufficient number of input arcs so that their operation may be performed, whereupon they consume those tokens and produce new tokens on their output arcs. For example: A node which performs an addition of two tokens will wait until tokens have appeared upon both its inputs, consume those two tokens and then produce the result (in this case the sum of the input tokens' data) as a new token on its output arc.

Rather than, as is done in a CPU, selecting different operations to operate on the data depending on conditional branches, a Data Flow Machine directs the data to different nodes depending on conditional branches through dataflow control nodes. Thus a Data Flow Machine has nodes that may selectively produce tokens on specific outputs (called a switch-node) and also nodes that may selectively consume tokens on specific inputs (called a merge-node). Another example of a common data flow control node is the gate-node which selectively removes tokens from the data flow. Many other data flow manipulating nodes are also possible.

Each node in the graph may potentially perform its operation independently from all the other nodes in the graph. As soon as a node has data on its relevant input arcs, and there is space to produce a result on its relevant output arcs, the node may execute its operation (known as firing). The node will fire regardless of other nodes being able to fire or not. Thus, there is no specific order in which the nodes' operations will execute, such as in a control-flow apparatus; the order of executions of the operations in the data flow graph is irrelevant. The order of execution could for example be simultaneous execution of all nodes that may fire.

As mentioned above, Data Flow Machines are, depending on their designs, normally divided into three different categories: static Data Flow Machines, dynamic Data Flow Machines, and synchronous Data Flow Machines.

In a static Data Flow Machine, every arc in the corresponding data flow graph may only hold a single token at every time instant.

In a dynamic Data Flow Machine each arc may hold an indefinite number of tokens while waiting for the receiving node to be prepared to accept them. This allows construction of recursive procedures with recursive depths that are unknown when designing the Data Flow Machine. Such procedures may reverse data that are being processed in the recursion. This may result in wrong matching of tokens when performing calculations after the recursion is finished.

The situation above may be handled by adding markers which indicates a serial number of every token in the protocol. The serial numbers of the tokens inside the recursion are continuously monitored, and when a token exits the recursion it is not allowed to proceed as long as it can not be matched to tokens outside the recursion.

In case the recursion is not a tail recursion, context have to be stored in the buffer at every recursive call in the same way as context is stored on the stack when recursion is performed by use of an ordinary (von Neumann) processor. Finally a dynamic Data Flow Machine may execute data-dependent recursions in parallel.

Synchronous Data Flow Machines can operate without the ability to let tokens wait on an arc while the receiving node prepares itself. Instead, the relationship between production and consumption of tokens for each node is calculated in advance. With this information it is possible to determine how to place the nodes and assign sizes to the arcs with regard to the number of tokens that may simultaneously reside on them. Thus it is possible to ensure that each node produces as many tokens as a subsequent node consumes. The system may then be designed so that every node always may produce data since a subsequent node will always consume the data. The drawback is that no indefinite delays such as data-dependent recursion may exist in the construction.

Data Flow Machines are most commonly put into practice by means of computer programs run in traditional CPUs. Often a cluster of computers is used, or an array of CPUs on some printed circuit board. The main purpose for using dataflow machines has been to exploit their parallelism to construct experimental super-computers. A number of attempts have been made to construct dataflow machines directly in hardware. This has been done by creating a number of processors in an Application Specific Integrated Circuit (ASIC). The main advantage of this approach in contrast to using processors on a circuit board is the higher communication rates between the processors on the same ASIC. Up till now, none of the attempts at using dataflow machines for computation have become commercially successful.

Field Programmable Gate Arrays (FPGA) and other Programmable Logic Devices (PLD) may also be used for hardware construction. FPGAs are silicon chips that are re-configurable on the fly. They are based on an array of small random access memories, usually Static Random Access Memory (SRAM). Each SRAM holds a look-up table for a boolean function, thus enabling the FPGA to perform any logical operation. The FPGA also holds similarly configurable routing resources allowing signals to travel from SRAM to SRAM.

By assigning the logical operations of a silicon chip to the SRAMs and configuring the routing resources, any hardware construction small enough to fit on the FPGA surface may be implemented. An FPGA can implement much fewer logical operations on the same amount of silicon surface compared to an ASIC. The advantage of an FPGA is that it can be changed to any other hardware construction, simply by entering new values into the SRAM look-up tables and changing the routing. An FPGA can be seen as an empty silicon surface that can accept any hardware construction, and that can change to any other hardware construction at very short notice (less than 100 milliseconds).

Other common PLDs may be fuse-linked, thus being permanently configured. The main advantage of a fuse-linked PLD over an ASIC is the ease of construction. To manufacture an ASIC, a very expensive and complicated process is required. In contrast, a PLD can be constructed in a few minutes by a simple tool. There are a number of evolving techniques for PLDs that may overcome some of the disadvantages, both for fuse-linked PLDs and FPGAs.

Generally, in order to program the FPGA, the place-and-route tools provided by the vendor of the FPGA must be used. The place-and-route software normally accepts either a netlist from a synthesis software or the source code from a Hardware Description Language (HDL) that it synthesizes directly. The place-and-route software then outputs digital control parameters in a description file used for programming the FPGA in a programming unit. Similar techniques are used for other PLDs.

When designing integrated circuits, it is common practice to design the circuitry as state machines since they provide a framework that simplifies construction of the hardware. State machines are especially useful when implementing complicated flows of data, where data will flow through logic operations in various patterns depending on prior calculations.

State machines also allow re-use of hardware elements, thus optimizing the physical size of the circuit. This allows integrated circuits to be manufactured at lower cost.

By building a super-computer with large numbers of processors in the form of a Data Flow Machine, the hope has been to achieve a high degree of parallelism. Attempts have been made where the processors either consisted of many CPUs or many ASICs, each comprising many state machines or CPUs. Since designs of earlier Data Flow Machines have included the use of state machines (usually in the form of processors) in ASICS, the most straightforward method to implement Data Flow Machines in programmable logical devices like FPGA would also be to use state machines. A general feature for all previously known Data Flow Machines is that the nodes of an established data flow graph do not correspond to specific hardware units (commonly known as functional units, FU) in the final hardware implementation. Instead, hardware units that happens to be available at a specific time instant are used for performing calculations specified by the nodes affected in the data flow graph. If a specific node in the data flow graph is to be performed more than once, different functional units may be used every time the node is performed.

Further, previous Data Flow Machines have all been implemented by the use of state machines or processors to perform the function of the Data Flow Machine. Each state machine is capable of performing the function of any node in the data flow graph. This is required to enable each node to be performed in any functional unit. Since each state machine is capable of performing any node's function, the hardware required for any other node apart from the currently executing node will be dormant. It should be noted that the state machines (sometimes with supporting hardware for token manipulation) are the realization of the Data Flow Machine itself. It is not the case that the Data Flow Machine is implemented by some other means, and happens to contain state machines in its functional nodes.

Though the design of hardware in a high-level language is desirable in general, there are special advantages in the case of an FPGA. Since FPGAs are re-configurable, a single FPGA can accept many different hardware designs. To fully utilize this ability, a much easier way of specifying designs than traditional hardware description languages is necessary. For an FPGA, the benefits of a high-level language might even outweigh a cost in efficiency of the finished design, something which would not be true for the design of an ASIC. Through the construction of a Data Flow Machine in an FPGA, a high-level language may be used to achieve an efficient hardware design for an FPGA.

The document “A Denotational Semantics for Dataflow with Firing” by Edward A. Lee, Electron. Res. Lab., Univ. California, Berkeley, Calif., Memo UCB/ERL M97/3, January 1997, which is hereby incorporated by reference, discloses the formal semantics of a Data Flow Machine. A machine implemented according to the semantics laid out in the document is an example of what a person skilled in the art would recognize as a Data Flow Machine.

WO 0159593, which is hereby incorporated by reference, discloses the compilation of a high-level software-based description of an algorithm into digital hardware implementations. The semantics of the programming language is interpreted through the use of a compilation tool that analyzes the software description to generate a control and data flow graph. This graph is then the intermediate format used for optimizations, transformations and annotations. The resulting graph is then translated to either a register transfer level or a netlist-level description of the hardware implementation. A separate control path is utilized for determining when a node in the flow graph shall transfer data to an adjacent node. Parallel processing may be achieved by splitting the control path and the data path. By using the control path, “wavefront processing” may be achieved, which means that data flows through the actual hardware implementation as a wavefront controlled by the control path.

The use of a control path implies that only parts of the hardware may be used while performing data processing. The rest of the circuitry is waiting for the first wavefront to pass through the flow graph, so that the control path may launch a new wavefront.

A Data Flow Machine is described in WO2004084086, which is hereby incorporated by reference, which discloses a method for generating descriptions of digital logic from high-level source code specifications. At least part of the source code specification is compiled into a multiple directed graph representation comprising functional nodes with at least one input or one output, and connections indicating the interconnections between the functional nodes. Hardware elements are defined for each functional node of the graph and for each connection between the functional nodes. Finally, a firing rule for each of the functional nodes of the graph is defined.

For the Data Flow Machines discussed above, it is of major interest to optimize data flow to achieve improved performance. It is therefore a problem how to increase performance for an existing hardware. It is further a problem to avoid deadlock in processing. It is further a problem how to implement a data flow machine in hardware, in particular in an automated fashion.

### SUMMARY OF THE INVENTION

In view of the above, an objective is to solve or at least reduce one or more of the problems discussed above.

An objective is to improve performance in relation to data paths that diverge from a first node and then converge in a second node.

With reference to this objective, a present invention is based on the understanding that balancing data flow paths diverging in a first node and converging in a second node will avoid halting nodes in the data flow. Applying this understanding in generating digital control parameters for implementation of digital logic circuitry will enable improved performance and/or saving of area resources of the hardware in which the digital logic circuitry is implemented. This present invention is further based on the understanding that, although the examples provided in this disclosure do not reflect the actual complexity, for the sake of clarity and readiness in understanding the principles of the invention, the kind of calculations required for implementing a digital logic circuitry according to the present invention is facilitated by computer implementation. The present invention is further based on the understanding that performance of the digital logic circuitry can be improved both by speeding up parts of the implementation, as well as slowing down parts of the implementation.

According to a first aspect of this present invention, there is provided an apparatus for generating digital control parameters for implementing a Data Flow Machine in a digital logic circuitry comprising functional nodes with at least one input or at least one output and connections indicating interconnections between said functional nodes, wherein said digital logic circuitry comprises a first path streamed by successive tokens and a second path streamed by said tokens, comprising a determinator for necessary relative throughput for data flow to said paths; an assigner of buffers to one of said paths to balance throughput of said paths; a remover of assigned buffers arranged to remove assigned buffers until said necessary relative throughput is obtained with minimized number of buffers; and digital control parameters generator for implementing said digital logic circuitry comprising said minimized number of buffers.

This implies that the number of halts in said first and second paths are kept to a level where it does not degrade performance of the overall digital logic circuit with a reduced consumption of hardware resources.

The first and second paths may be parallel or in series.

The removal of assigned buffers may be performed with regard to available space also for other parts of said implementation of said digital logic circuitry, relative throughput of said paths, and relative throughput of the rest of said implementation of said digital logic circuitry. This way, the overall performance of the digital logic circuit is improved, and hardware resources can be used where most appropriate.

Said at least one of said paths may comprise at least two functional nodes wherein a first of said functional nodes has a first relative throughput and a second of said nodes has a second relative throughput, wherein said second relative throughput is adapted to be equal to said first relative throughput by iteration or pipelining of said second functional node. This enables improvement of the relative throughput matching on a processing path, which enables further improvement of the overall performance for a given hardware resource.

The principle may also be applied to the apparatus for implementing the digital logic circuitry where the paths are in series. The digital control parameters may control a Field Programmable Gate Array (FPGA) to implement the digital logic circuitry. The Data Flow Machine may be generated from high-level source code specifications. An advantage of this is that the usefulness of FPGAs may be vastly increased, since many logic circuits for an FPGA may be easily created. This allows the FPGA to be used as a very fast general purpose calculation device by normal software programmers, where a specific FPGA can be quickly programmed for a large number of completely different circuits. The digital control parameters may control an Application Specific Integrated Circuit (ASIC) or a chip to implement the digital logic circuitry. The Data Flow Machine may be generated from high-level source code specifications. This enables a user-friendly, and thus efficient operation of the apparatus.

According to a second aspect of this present invention, there is provided a method of generating digital control parameters for implementing a Data Flow Machine in a digital logic circuitry comprising functional nodes with at least one input or at least one output and connections indicating interconnections between said functional nodes, wherein said digital logic circuitry comprises a first path streamed by successive tokens, and a second path streamed by said tokens, comprising determining a necessary relative throughput for data flow to said paths; assigning buffers to one of said paths to balance throughput of said paths; removing assigned buffers until said necessary relative throughput is obtained with minimized number of buffers; and generating digital control parameters for implementing said digital logic circuitry comprising said minimized number of buffers.

The removing may be performed with regard to available space also for other parts of said implementation of said digital logic circuitry, relative throughput for said paths, and relative throughput for the rest of said implementation of said digital logic circuitry.

The method may comprise implementing the digital logic circuitry by means of an FPGA. The method may comprise implementing the digital logic circuitry by means of an Application Specific Integrated Circuit (ASIC) or a chip. The method may comprise generating the Data Flow Machine from high-level source code specifications.

According to a third aspect of this present invention, there is provided a computer program product comprising program code arranged to perform the method according to the second aspect of the invention when downloaded to and executed by a computer.

According to a fourth aspect of this present invention, there is provided a computer implementable digital logic circuitry comprising functional nodes with at least one input or at least one output and connections indicating interconnections between said functional nodes implementing a Data Flow Machine, a first path streamed by successive tokens, and a second path streamed by said tokens, comprising a minimized number of added buffers, wherein said number of added buffers is minimized by determining a necessary relative throughput for data flow to said paths; assigning buffers to one of said paths to balance throughput of said paths; and removing assigned buffers until said necessary relative throughput is still obtained.

The first and second paths may be parallel. The removal of assigned buffers may be performed with regard to available space also for other parts of said implementation of said digital logic circuitry, relative throughput of said paths, and relative throughput of the rest of said implementation of said digital logic circuitry. At least one of said paths may comprise at least two functional nodes wherein a first of said functional nodes has a first relative throughput and a second of said nodes has a second relative throughput, wherein said second relative throughput is adapted to be equal to said first relative throughput by iteration or pipelining of said second functional node. The first and second paths may be in series. The circuitry may be implemented by means of an FPGA. The circuitry may be implemented by means of an Application Specific Integrated Circuit (ASIC) or a chip. The nodes and connections implementing the Data Flow Machine may be generated from high-level source code specifications.

According to a fifth aspect of this present invention, there is provided a Data Flow Machine comprising functional nodes with at least one input or at least one output and connections indicating interconnections between said functional nodes, a first path streamed by successive tokens, and a second path streamed by said tokens, comprising a minimized number of added buffers, wherein said number of added buffers is minimized by determining a necessary relative throughput for data flow to said paths; assigning buffers to one of said paths to balance throughput of said paths; and removing assigned buffers until said necessary relative throughput is still obtained.

According to a sixth aspect of this present invention there is provided a method for determining a number of buffers for a digital logic circuitry implementing a Data Flow Machine, comprising identifying a first path streamed by successive tokens, and a second path streamed by said tokens; determining a necessary relative throughput for data flow to said paths; assigning buffers to one of said paths to balance throughput of said paths; and removing assigned buffers until said necessary relative throughput is obtained with minimized number of buffers.

The method may further comprise introducing faster nodes, or faster algorithms, or any combination thereof, to one of said paths to minimize the number of buffers. The faster nodes may comprise parallel or pipelined processing.

Alternatively, the method may further comprise introducing smaller nodes or less demanding algorithms, or any combination thereof, to one of said paths to minimize the number of buffers. The smaller nodes may be arranged to perform iterative operations, or shared operations, or any combination thereof.

The term “shared operations” should in this context be construed to mean that a piece of hardware used to implement a node may also be used for operation of other nodes.

According to a seventh aspect of this present invention, there is provided a computer program product comprising program code arranged to perform the method according to the sixth aspect of the present invention when downloaded to and executed by a computer.

According to an eighth aspect of this present invention, there is provided a method for determining relative throughput in a digital logic circuitry comprising nodes and connections implementing a Data Flow Machine, comprising defining at least a part of said digital logic circuitry; determining relative throughput for each node and connection in said part; determining data flow paths through said nodes and connections; determining the number of tokens flowing through each path; and determining, from said data flow paths, the number of tokens flowing through each path, and digital logic circuitry, a relative throughput for said part.

Defining said part may comprise determining nodes and connections in a relative throughput area between a first flow control node and a second flow control node. The flow control nodes may each comprise a gate, a merge, a non-deterministic merge, a switch, a duplicator node, an input, an output, a source, a sink or any combination thereof.

According to a ninth aspect of this present invention, there is provided a computer program product comprising program code arranged to perform the method according to the eight aspect of this present invention when downloaded to and executed by a computer.

The second to ninth aspects of this present invention essentially provide similar advantages as demonstrated above for the first aspect of the invention.

An objective is to avoid deadlock in the digital logic circuitry.

With reference to this objective, a present invention is based on the understanding that digital logic circuitry can be considered to involve uniform throughput areas, i.e. areas where no unconnected nodes exist and in which load on processing nodes is balanced such that no node need to halt until necessary input data is provided from other nodes. For optimizing data flow machines, the implementation of a digital logic circuitry in hardware requires adaptation of the data flow graph to avoid deadlock. This is facilitated by determining loops from a determined uniform throughput area, i.e. a data flow path that leaves the uniform throughput area to other processing nodes outside the determined uniform throughput area, to a region where nodes have lower throughput, and then returns to a node of the same uniform throughput area again. Such a loop is a potential cause of deadlock unless dealt with.

According to a first aspect of this present invention, there is provided an apparatus for generating digital control parameters for implementing a data flow machine in a digital logic circuitry comprising functional nodes with at least one input or at least one output and connections indicating interconnections between said functional nodes, wherein a first set of functional nodes and connections are included in a first uniform throughput area, said first set comprises a first connection from a first node of said first uniform throughput area to a second area outside said first uniform throughput area, and said second area comprises a second connection to a second functional node of said first uniform throughput area, wherein said digital logic circuitry comprises at least as many additional buffers as a largest number of tokens that will pass through a first path in said first area from said first node to said second node while two tokens pass through a second path comprising said first and second connections in said second area from said first node to said second node, said buffers being arranged on said second path to prevent deadlock.

An advantage of this is that the buffers will make necessary tokens available during processing, which will avoid deadlock.

To be sure that deadlock will not occur because of the loop comprising the first and second connections, i.e. the second path, it may be ensured that the number of buffers on the paths between the first and second nodes is the number of tokens that will pass through the first path divided by the number of tokens that will pass through the second path.

It should be noted that the loop may be an edge, i.e. a pure wiring, only, but with a lower throughput than the edges inside the first uniform throughput area.

The second area may further comprise at least one functional node in said second path.

Said one or more buffers may be arranged in said first uniform throughput area.

The apparatus may be arranged to optimise throughput of said first uniform throughput area and said second uniform throughput area with regard to available space for other parts of said implementation of said digital logic circuitry and throughput for the rest of said implementation of said digital logic circuitry. The optimisation may comprise iteration or pipelining, or any combination thereof, of a functional node or a group of functional nodes of said digital logic circuit.

The digital control parameters may control a Field Programmable Gate Array (FPGA) to implement the digital logic circuitry. The data flow machine may be generated from high-level source code specifications. An advantage of this is that the usefulness of FPGAs may be vastly increased, since many logic circuits for an FPGA may be easily created. This allows the FPGA to be used as a very fast general purpose calculation device by normal software programmers, where a specific FPGA can be quickly programmed for a large number of completely different circuits.

The digital control parameters may control an Application Specific Integrated Circuit (ASIC) or a chip, or any combination thereof, to implement the digital logic circuitry.

According to a second aspect of this present invention, there is provided a method for preventing deadlock in a data flow machine implemented by digital logic circuitry comprising functional nodes with at least one input or at least one output and connections indicating interconnections between said functional nodes, comprising determining a first uniform throughput area comprising one or more functional nodes or connections with a first uniform throughput; determining a first connection from a first node of said first uniform throughput area to a second area comprising one or more functional nodes or connections; determining a second connection to a second functional node of said first uniform throughput area from said second area; and adding as many buffers as a largest number of tokens that will pass through a first path in said first area from said first node to said second node while two tokens pass through a second path comprising said first and second connections in said second area from said first node to said second node, arranging said buffers on said second path in said second area to said digital logic circuitry to prevent deadlock due to said first connection and said second connection.

The method may assign the number of buffers on said paths between the first and second nodes to be the number of tokens that will pass through the first path divided by the number of tokens that will pass through the second path.

The second area may further comprise at least one functional node in a path comprising said first and second connection.

Adding one or more buffers may be performed in said first uniform throughput area.

The method may further comprise optimising throughput of said first uniform throughput area and said second area with regard to available space for other parts of said implementation of said digital logic circuitry and throughput for the rest of said implementation of said digital logic circuitry. The optimisation may comprise iterating or pipelining, or any combination thereof, of a functional node or a group of functional nodes of said digital logic circuitry.

The method may comprise implementing said digital logic circuitry by means of an FPGA. The method may comprise implementing the digital logic circuitry by means of an ASIC or a chip. The method may comprise generating said data flow machine from high-level source code specifications.

According to a third aspect of this present invention, there is provided a computer program product comprising program code arranged to perform the method according to the second aspect of this present invention when downloaded to and executed by a computer.

According to a fourth aspect of this present invention, there is provided a computer implementable digital logic circuitry comprising functional nodes with at least one input or at least one output and connections indicating interconnections between said functional nodes implementing a data flow machine, wherein a first set of functional nodes and connections are included in a first uniform throughput area, said first set comprises a first connection from a first node of said first uniform throughput area to a second area outside said first uniform throughput area, and said second area comprises a second connection to a second functional node of said first uniform throughput area, wherein said digital logic circuitry comprises as many additional buffers as a largest number of tokens that will pass through a first path in said first area from said first node to said second node while two tokens pass through a second path comprising said first and second connections in said second area from said first node to said second node, said buffers being arranged on said second path in said second area to prevent deadlock due to said first connection, and said second connection.

An advantage of this is a digital logic circuitry which is easy to implement by means of software support, and which enables the high performance of a data flow machine. Further, the advantages are similar to those demonstrated for the above aspects of this present invention.

To be sure that deadlock will not occur in the digital logic circuitry because of the loop comprising the first and second connections, it may be ensured that the number of buffers on said paths between said first and second nodes is the number of tokens that will pass through the first path divided by the number of tokens that will pass through said second path.

The second area may further comprise at least one functional node in the second path. Said said one or more buffers may be arranged in said first uniform throughput area.

The circuitry may be optimised for throughput of said first uniform throughput area and second area with regard to available space for other parts of said implementation of said digital logic circuitry and throughput for the rest of said implementation of said digital logic circuitry. The optimisation may comprise iteration or pipelining, or any combination thereof, of a functional node or a group of functional nodes of said digital logic circuit.

The circuitry may be implemented by means of an FPGA. The circuitry may be implemented by means of an ASIC or a chip. The nodes and connections implementing the data flow machine may be generated from high-level source code specifications.

According to a fifth aspect of this present invention, there is provided a data flow machine comprising functional nodes with at least one input or at least one output and connections indicating interconnections between said functional nodes, wherein a first set of functional nodes and connections are included in a first uniform throughput area, said first set comprises a first connection from a first node of said first uniform throughput area to a second area outside said first uniform throughput area, and said second area comprises a second connection to a second functional node of said first uniform throughput area, wherein said digital logic circuitry comprises as many additional buffers as a largest number of tokens that will pass through a first path in said first area from said first node to said second node while two tokens pass through a second path comprising said first and second connections in said second area from said first node to said second node, said buffers being arranged on said second path in said second area to prevent deadlock due to said first connection, and said second connection.

The data flow machine may be implemented by means of an FPGA, an ASIC, or a chip. The data flow machine may be generated from high-level source code specifications. The data flow machine may be automate generated.

In particular, an objective is to implement a data flow machine.

With reference to this objective, a present invention is based on the understanding that nodes in a data flow machine can have three signal sets: two working in a forward direction presenting a data signal and a validity of data signal, and one working in a backward direction presenting a consume signal. The validity of data signal holds information on whether there are valid input data present at data inputs and outputs of the node, and the consume signal holds information whether the output data of the node have been consumed and if data is to be consumed from preceding nodes. This enables applying firing rules of a dataflow machine. To enable an asynchronous data flow, certain care should be taken by implementing the data flow machine.

According to a first aspect of this present invention, there is provided a computer implementable digital logic circuit comprising a plurality of nodes and a plurality of connections connecting said nodes to implement a data flow machine, wherein each of said nodes comprises at least one signal set for data signals, comprising at least one data signal from a preceding node provided at an input and at least one data signal to a subsequent node provided at an output, at least one signal set for data validity signals holding information on if there are valid data on said data signal inputs and outputs, comprising at least one data valid signal from a preceding node provided at an input and at least one data valid signal from a preceding node provided at an output, and at least one signal set for a consume signal holding information on if said data signals are consumed comprising at least one consume signal from a subsequent node provided at an input and at least one consume signal to a preceding node provided at an output, wherein each of said nodes is arranged such that logical dependence on any of said data valid signals, which is logically depending on a first consume signal, is excluded for said first consume signal, and logical dependence on any of said consume signals, which is logically depending on a first valid data signal, is excluded for said first valid data signal signal.

This implies that the digital logic circuitry can be provided by automated implementation, due to the provided modularity of the nodes.

Each of said nodes may comprise a first number of data signal inputs and a second number of data signal outputs, comprises said first number of valid data input signals and consume input signals, and said second number of valid data output signals and consume output signals.

This implies that data flow control is provided for all inputs and outputs of data.

The invention enables that at least a part of said data flow machine may be asynchronous.

At least a part of the digital logic circuitry may be generated by a computer. The circuitry may be implemented by means of a Field Programmable Gate Array (FPGA), an Application Specific Integrated Circuit (ASIC) or a chip, or any combination thereof.

The node may comprise a combinatory logic, a pipeline, or a state machine, or any combination thereof, for performing an operations of the node.

The nodes and connections implementing the dataflow machine may be generated from high-level source code specifications.

According to a second aspect of this present invention, there is provided a method for automated implementation of a digital logic circuit comprising a data flow machine in a hardware, comprising determining an abstract data flow machine; determining nodes and connections for said data flow machinewherein, wherein each of said nodes comprises at least one signal set for data signals, comprising at least one data signal from a preceding node provided at an input and at least one data signal to a subsequent node provided at an output, at least one signal set for data validity signals holding information on if there are valid data on said data signal inputs and outputs, comprising at least one data valid signal from a preceding node provided at an input and at least one data valid signal from a preceding node provided at an output, and at least one signal set for a consume signal holding information on if said data signals are consumed comprising at least one consume signal from a subsequent node provided at an input and at least one consume signal to a preceding node provided at an output; determining a firing rule for said nodes where logical dependence on any of said data valid signals, which is logically depending on a first consume signal, is excluded for said first consume signal, and logical dependence on any of said consume signals, which is logically depending on a first valid data signal, is excluded for said first valid data signal signal; and assigning said nodes, connections, and firing rules to a programmable hardware.

The method may further comprise implementing said digital logic circuitry by means of an FPGA, an ASIC or a chip, or any combination thereof.

The method may further comprise generating paid data flow machine from high-level source code specifications.

According to a third aspect of this present invention, there is provided a computer program product directly loadable into a memory of an electronic device having digital computer capabilities, comprising software code portions for performing the method according to the second aspect of this present invention when executed by said electronic device.

According to a fourth aspect of this present invention, there is provided an apparatus for generating digital control parameters for implementing a digital logic circuitry comprising a data flow machine according to the first aspect of this present invention. The apparatus is arranged to perform the method according to the second aspect of this present invention.

The digital control parameters may control an Field Programmable Gate Array (FPGA) to implement the digital logic circuitry. The data flow machine may be generated from high-level source code specifications. An advantage of this is that the usefulness of FPGAs may be vastly increased, since many logic circuits for an FPGA may be easily created. This allows the FPGA to be used as a very fast general purpose calculation device by normal software programmers, where a specific FPGA can be quickly programmed for a large number of completely different circuits.

The advantages of the second, third and fourth aspects of this present invention is that the advantageous digital logic circuitry according to the first aspect of this present invention is readily enabled.

An objective is to provide structures for implementing loops of a data flow machine.

With reference to this objective, a present invention is based on the understanding that a basic mechanism of a dataflow machine is that a node will perform its operation when it has all its input, consuming its input and producing the relevant output (if any). The node will not perform any operation until it has sufficient inputs. Any input that arrives ahead of time simply waits on the edge before the node until sufficient input for the node's operation has arrived. If an output edge of a node is occupied, it will delay activation until the edge is freed. This feature is taken advantage of in the for-loops with initial tokens (values) on some of the edges.

According to a first aspect of this present invention, there is provided a dataflow machine comprising a merge node comprising an input for new values to be iterated, an input for iterated values, and an output for iterated values, and further comprising a loop body function unit having an input connected to the output for iterated values of the merge node, and a switch node comprising an input for iterated values connected to an output of the loop body function unit, an output for iterated values connected to the input for iterated values of the merge node, and an output exiting the loop.

The dataflow machine may comprise a second merge node comprising an input for new values to be iterated, an input for iterated values, and an output for iterated values connected to an input of the loop body function unit.

The dataflow machine may comprise a second switch node comprising an input for iterated values connected to an output of the loop body function unit, an output for iterated values connected to the input for iterated values of the merge node, and an output exiting the loop. Here this merge node can be either the only merge node present, or any merge node if several are present in the structure, for implementing e.g. foreach-loop, for-loop, while-loop, do-while-loop, re-entrant-loop, or any of these in combination. The loops may iterate on scalars, or iterate across a collection, e.g. across a list or vector. Here, iterating across a list means that one element at a time is taken from the collection, while iterating across a vector means that all elements of the collection are iterated on simultaneously.

Here, the term ‘connected to’ may mean both directly connected to and connected via one or more further elements, such as buffers, splitters, joiners, duplicators, further loop body functions, etc.

Generally, all terms used in the claims are to be interpreted according to their ordinary meaning in the technical field, unless explicitly defined otherwise herein.

All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

The terms “first”, “second”, etc. is only to be construed to define different elements, measures, etc. where otherwise not explicitly expressed.

Other objectives, features and advantages of this present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a diagram illustrating a part of a data flow graph;

FIG. 2 is a diagram illustrating the part of the data flow graph of FIG. 1 after optimization according to an embodiment of the present invention;

FIG. 3 is a diagram illustrating a part of a data flow graph;

FIG. 4 is a diagram illustrating the part of the data flow graph of FIG. 3 after optimization according to an embodiment of the present invention;

FIG. 5 is a diagram illustrating a part of a data flow graph representing a data flow machine;

FIG. 6 is a diagram illustrating a simplified view of the diagram in FIG. 1, with an embodiment of the present invention applied;

FIGS. 7 to 19 are diagrams illustrating nodes adapted to use in the present invention;

FIGS. 20a to 20g illustrates examples of parts for illustrating the embodiments of the present invention illustrated in the drawings; and

FIGS. 21 to 47 illustrates various loops.

### DETAILED DESCRIPTION OF PREFERRED EMBODIMENTS

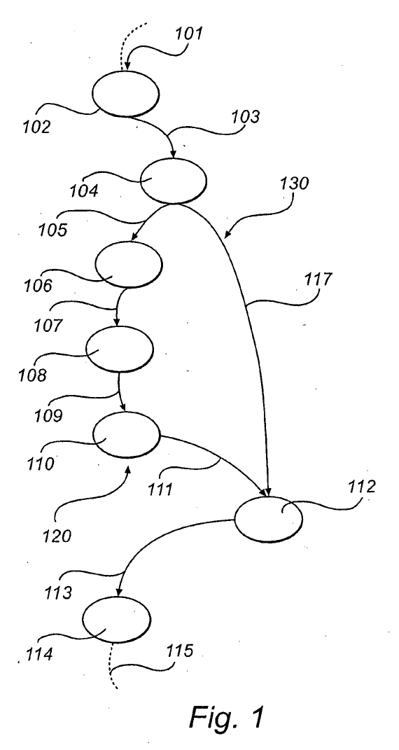

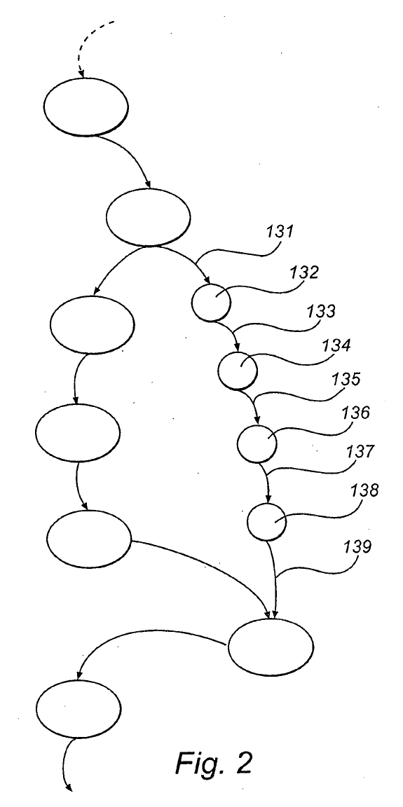

FIG. 1 illustrates an example of a part of a data flow graph comprising a plurality of nodes 102, 104, 106, 108, 110, 112, 114, each comprising at least one input and/or at least one output. The data flow between the nodes of the data flow graph is denoted by arcs 101, 103, 105, 107, 109, 111, 113, 115, 117. Each of said nodes 102, 104, 106, 108, 110, 112, 114 represent a logic operation performed on data present at the input of said nodes, respectively. The data present at the input of said nodes, normally referenced to as a token, can be considered to be held by said arcs, and the data held by said arcs are consequently the output of the nodes from which the arcs emanate, respectively. Regarding the example of FIG. 1, data on arc 101 is processed by node 102 and output to arc 103. The data on arc 103, which is present on the input of node 104, is processed by node 104, and the output from node 104 is output to arcs 105 and 117. Arc 117 is input to node 112, which cannot process the data since it do not have relevant data on arc 111, which is also input to node 112. Thus, node 104 have to halt processing until corresponding data has been processed by nodes 106, 108, 110 on a first path 120, comprising arcs and nodes 105, 106, 107, 108, 109, 110, 111, parallel to a second path, comprising arc 117, which can be considered as a second path 130. When the data on arc 111, corresponding to the data present on arc 117, is present, node 112 processes the data, and node 104 can lift its halt state, and the processing of next data present on arc 103 can be processed. This halt approach degrades performance of data processing. According to an embodiment of the present invention, a number of buffers corresponding to the process time of nodes 106, 108, 110 of path 120 are added. However, the number of buffers can be considerable, and the available space on the hardware in which a digital logic circuitry corresponding to the data flow graph is to be implemented may not be enough. Therefore, when generating control parameters for implementing the digital logic circuitry, optimization is made, considering both the speedup of data processing and the available space for the implementation in hardware, e.g. on an FPGA. This optimization may result in an adapted data flow graph illustrated in FIG. 2 to be implemented in hardware. The data flow graph of FIG. 2 comprises the nodes and arcs corresponding to the data flow graph of FIG. 1, and instead of arc 117 of FIG. 1 there is provided arcs 131, 133, 135, 137, 139 and buffers 132, 134, 136, 138. Here, considerations are made by the apparatus for generating the digital control parameters for implementing the digital logic circuitry, which apparatus for example is a computer comprising a processor, e.g. of von Neumann type, with a downloaded software for making the optimization and generating the control parameters. Thus, the apparatus is also capable of making data flow analysis to be able to determine the need of buffers and the number of buffers, and the implications of assigning fewer buffers, both on performance and area consumption. For example, if area is not an issue, e.g. when the digital logic circuitry is small compared to the available hardware resources, the number of buffers are optimized only on performance. If area is an issue, it is preferable that the entire implementation, of which the part presented in FIGS. 1 and 2 is only a part, is considered such that the performance of the implementation as a whole is optimized for the area resources. An approach according to an embodiment of the present invention is to assign buffers such that the parallel paths are balanced with regard to relative throughput, and then removing as many buffers as possible while maintaining a desired relative throughput of the two parallel paths in conjunction, i.e. a relative throughput that will not cause other parts of the digital logic circuitry to halt. In such a case, the number of buffers in the example demonstrated above may be reduced to two buffers, since other parts of the implementation will be limiting for performance anyway, and the area resources are better used for another optimization for another part of the data flow graph implementation. The example of FIGS. 1 and 2 illustrates a simple case where on one path, there is provided a reasonable number of nodes comprising processing, and on the other path, there is provided only an arc transporting data. However, the invention is equally applicable on two paths diverging and then converging, each comprising a plurality of nodes, but requiring different processing time. Here, we introduce the expression “choke”, which is a figure on how much processing effort is required for an operation or a group of operations. Choke can be considered to be the inverse of relative throughput of a node or a group of nodes. Now this expression is defined, the essence of the invention can be expressed as optimizing choke of parallel data flow paths to improve performance on a digital logic circuitry to be implemented.

To implement, some operations, pipelining, iterating and looping may be considered. In short, pipelining can reduce choke of an operation, but will increase use of area resources and is not always possible due to the data flow of the operation. Iterating an operation will increase choke, but will decrease use of area resources. Loops in the dataflow have to be considered to avoid deadlock.

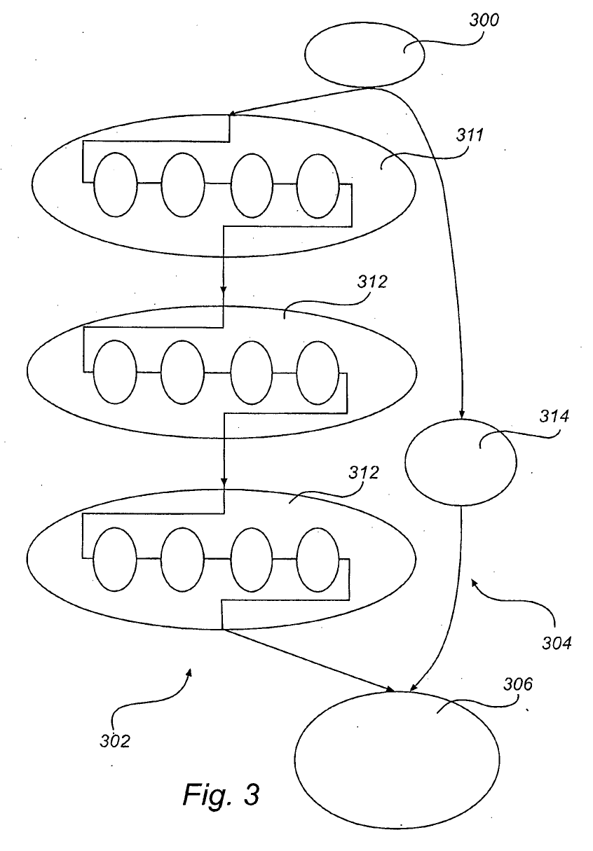

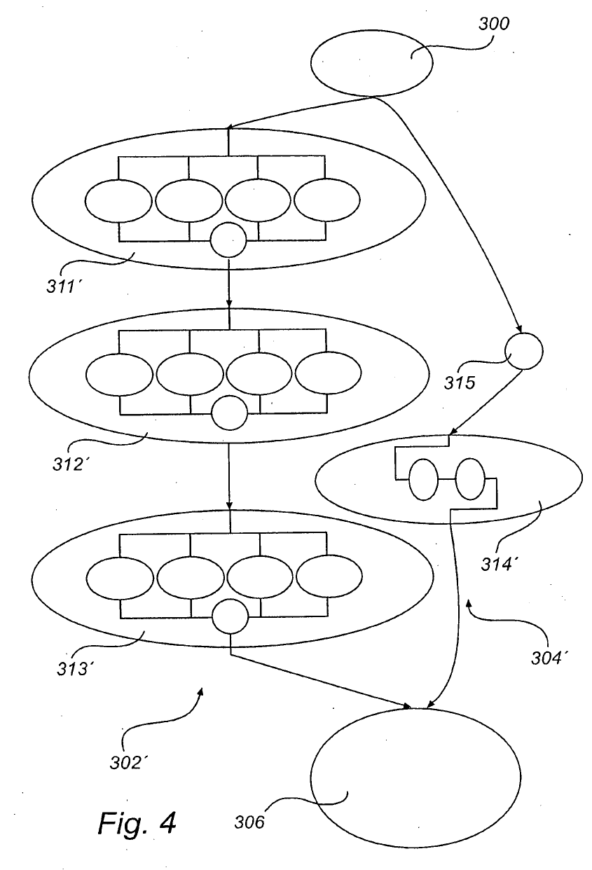

FIG. 3 illustrates a part of a data flow graph comprising a first path 302 and a second path 304 diverging from a node 300 and converging to a node 306. The first path 302 comprises three operations in nodes 311, 312, 313, each comprising four iterations. Thus, the choke of the first path is three times four, i.e. 12. The second path comprises one operation in node 314, and does thus have a choke of one. The choke of the two paths 302, 304 will be 12, since the node 314 of the second path 304 will have to be halted to wait for result from the last node 313 of the first path to enable node 306 to take care of the result. To optimize, i.e. balance, the two paths 302, 304 to improve performance, the data flow graph can be adapted as illustrated in FIG. 4, where the iterations of the operations of the nodes 311, 312, 313 of the second path has been pipelined as illustrated by nodes 311′, 312′, 313′ in FIG. 4. Thus, second path 302′ will have a choke of three. Consider that the operations of the node 314 of the second path 304 in FIG. 3 can be performed by iteration two times, as illustrated by node 314′ in FIG. 4, and thus save some hardware area. The second path would then have a choke of two, but a buffer 315 is inserted in the second path 304′, and the second path 304′ will have a choke of three. Thus, no node need to be halted, and for each clock cycle, corresponding data are provided to node 306.

Many permutations are possible by applying the approach of the present invention, and for saving space, it may be possible to introduce further iterations in node 314 and/or further buffers in path 304 to balance the paths 302, 304 to avoid halts. It is also possible to pipeline only one or two of the nodes in the first path 320 together with chosen measurements for the second path 304 to balance choke.

The digital logic circuit is implemented by generating digital control parameters, which are used for programming an ASIC, an FPGA, or a PLD. An apparatus for generating the digital control parameters normally comprises a processor and a computer program executed by the processor. The computer program is arranged to cause the processor to support generation of control parameters to implement the digital logic circuit. Thus, the apparatus is adapted to generate the digital control parameters according to the present invention as described above.

The invention is applicable to synchronous systems, asynchronous systems, and systems comprising both synchronous and asynchronous parts. Therefore, the term relative throughput has been used. Other terms for expressing the relative throughput, that may be used for specific systems, is for example bandwidth, choke, etc. Regions with different relative throughput can be defined by analyzing the entire data flow graph, node by node. All nodes do not produce and consume the same number of tokens at all arcs at every firing. This applies to data flow controlling nodes such as gate, merge, non-deterministic merge, switch, input, output, source, sink and duplicator nodes. Such nodes will have a relation between the number of tokens which are produced and consumed on their arcs, respectively. This relation can apply between any arcs, both between input and output, output and output, and input and input. Such nodes will define boundaries for regions with uniform throughput. The relation between activity on different input/output arcs will define the relative throughput relation. Balancing of relative throughput comprises either increasing throughput or decreasing use of hardware resources in a region, such that the use of hardware is minimal in relation to the relative throughput that a region requires. A goal can be to achieve maximal performance with a certain amount of hardware resources. Another goal can be to minimize the use of hardware resources that are used to achieve a certain performance in each region.

Throughput can be increased by using faster hardware elements, using other and faster algorithms to implement operations in nodes, and duplicating nodes to enable parallel or pipelined processing. For buffers, it can apply to make sure that all paths through a region will have at least almost equal number of buffers.

On the other side, throughput can be decreased, for example by using hardware elements that are smaller in size, iterative functions, using algorithms that require less hardware resources, and/or allowing nodes performing the same or similar operations share the same hardware resources. Here, for buffers, it applies that if there are not an equal number of buffers on all paths, less parallel operations can be enabled, which will imply less performance, but less buffers are used.

A reason for adapting throughput by increasing or decreasing the number of buffers can be illustrated by imagining a data path dividing into two, and then merge again. If one path comprises a long pipeline and there is enough of independent values to feed it, i.e the pipeline is full, and the other path only can hold one token, there will be a halt in the duplicator node where the paths divide when the short path is full. The token on the short path will wait for the token through the pipeline to be produced such that it can be combined. Thus, only one element at a time will be active in the pipeline. If both of the paths would be able to hold the same number of tokens, the pipeline would be able to be full. The present invention proposes to choose the number of buffers on the short path such that a required throughput can be chosen at the same time as the number of buffers is kept down.

Assuming a specific relative throughput is measured as a percentage of full relative throughput (a fraction between 0 and 1), the number of buffers required to attain a specific relative throughput is equal to the number of buffers required to balance the two paths for full relative throughput multiplied by the specific relative throughput. In regards to buffers, two paths are balanced for full relative throughput if the same number of buffers exists on both paths.

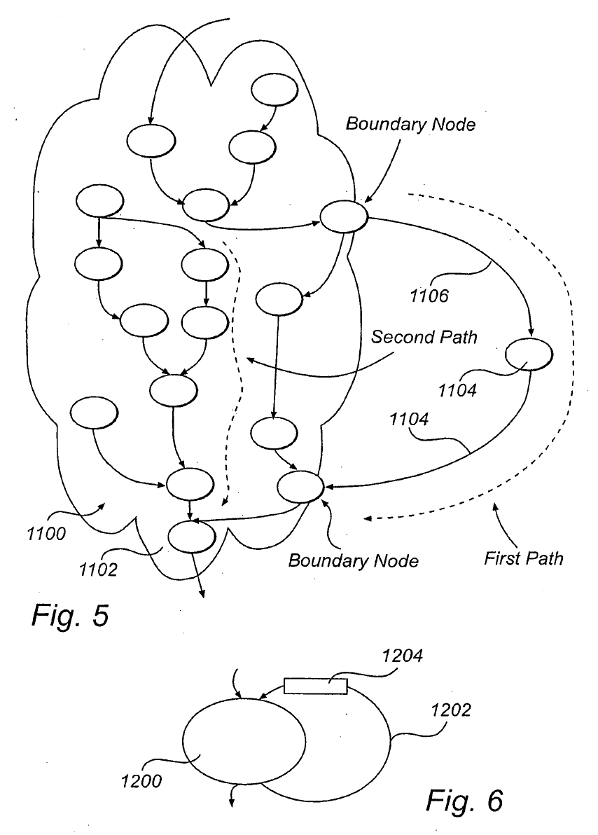

FIG. 5 illustrates an example of a part of a data flow graph representing a digital logic circuit comprising a plurality of nodes 1100, each comprising at least one input and/or at least one output, in a uniform throughput area 1102, and a possible node 1104 outside the uniform throughput area 1102. Said possible node 1104 can comprise a plurality of nodes and connections forming a second uniform throughput area (not shown). The data flow between the nodes of the data flow graph is denoted by arcs. Each of said nodes 1100, 1104 represent a logic operation performed on data present at the input of said nodes, respectively. The data present at the input of said nodes, normally referred to as tokens, can be considered to be held by said arcs, and the data held by said arcs are consequently the output of the nodes from which the arcs emanate, respectively. Regarding the example of FIG. 5, the uniform throughput area 1102, i.e. an area in which load on processing nodes is balanced such that no node need to halt until necessary input data is provided from other nodes, comprises a connection 1106 from one of its nodes 1100 to the node 1104 outside the uniform throughput area 1102 and a connection 1108 from the node 1104 outside the uniform throughput area 1102 to a node inside the uniform throughput area, i.e. a data flow path that leaves the uniform throughput area and then returns to the same uniform throughput area again. For optimizing data flow machines, the implementation of a digital logic circuitry in hardware requires adaptation of the data flow graph to avoid deadlock. Such a loop is a potential cause of deadlock unless dealt with. All nodes in the region must be connected to both the input and output of the region, directly or via other nodes. Node 1104 is optional, thus the invention will work on a configuration comprising a connection from a node of the uniform throughput area 1102 to another node of the uniform throughput area 1102.

FIG. 6 illustrates an adapted view of the part of data flow graph of FIG. 5, where the nodes and connections inside the uniform throughput area 1102 is considered as a complex node 1200. By regarding the path comprising the connections 1106, 1108 and the node 1104 in FIG. 5 as a loop 1202, deadlock problems can be dealt with when generating digital control parameters for implementing the digital logic circuitry. To ensure that deadlock will not occur because of the loop 1202, the invention provides that as many buffers 1204 are present on all paths between the input and output of the complex node 1200 as the number of tokens that will pass through the complex node 1200, i.e. the uniform throughput area 1102 of FIG. 5, divided by the number of tokens that will pass through the loop 1202. The invention has mainly been described above with reference to a few embodiments. However, as is readily appreciated by a person skilled in the art, other embodiments than the ones disclosed above are equally possible within the scope of the invention, as defined by the appended patent claims.

The invention is applicable to synchronous systems, asynchronous systems, and systems comprising both synchronous and asynchronous parts. Therefore, the term relative throughput has been used. Other terms for expressing the relative throughput, that may be used for specific systems, is for example bandwidth, choke, etc. Regions with different relative throughput can be defined by analyzing the entire data flow graph, node by node. All nodes do not produce and consume the same number of tokens at all arcs at every firing. This applies to data flow controlling nodes such as gate, merge, switch, and duplicator nodes. Such nodes will have a relation between the number of tokens which are produced and consumed on their arcs, respectively. This relation can apply between any arcs, both between input and output, output and output, and input and input. Such nodes will define boundaries for regions with uniform throughput. The relation between activity on different input/output arcs will define the relative throughput relation. Though the design of hardware in a high-level language is desirable in general, there are special advantages in the case of an FPGA. Since FPGAs are re-configurable, a single FPGA can accept many different hardware designs. To fully utilize this ability, a much easier way of specifying designs than traditional hardware description languages is necessary. For an FPGA, the benefits of a high-level language might even outweigh a cost in efficiency of the finished design, something which would not be true for the design of an ASIC.

In order to implement a data flow machine in the digital logic circuitry, each node will be provided with a firing rule which defines a condition for the node to provide data at its output and consume data at its input. More specifically, firing rules are the mechanisms that control the flow of data in the data flow graph. By the use of firing rules, data are transferred from the inputs to the outputs of a node while the data are transformed according to the function of the node. Consumption of data from an input of a node may occur only if there really are data available at that input. Correspondingly, data may only be produced at an output if there is space to accept the data. At some instances it is, however, possible to produce data at an output even though old data block the path; the old data at the output will then be replaced with the new data.

A specification for a general firing rule normally comprises:
1) the conditions for each input of the node in order for the node to consume the input data,
2) the conditions for each output of the node in order for the node to produce data at the output, and
3) the conditions for executing the function of the node.

The conditions normally depend on the values of input data, existence of valid data at inputs or outputs, the result of the function applied to the inputs or the state of the function, but may in principle depend on any data available to the system. The semantics for the firing rules set forth in the document “A Denotational Semantics for Dataflow with Firing” by Edward A. Lee, which is hereby incorporated by reference, may be adhered to. For non-deterministic operations, special re-ordering and token matching functionality may be added in hardware to ensure deterministic operation of the data flow machine, unless the ordering of tokens does not influence the operation of the machine after the non-deterministic operations.

By establishing general firing rules for the nodes of the system, it is possible to control various types of programs without the need of a dedicated control path. However, by means of firing rules it is possible, for some special cases, to implement a control flow. Another special case is a system without firing rules, wherein all nodes operates only when data are available at all the inputs of the nodes.

To be able to automatically implement the digital logic circuitry from a tool for creating data flow machines, it is advantageous to apply a modular approach to the implementation of the digital logic circuitry. Thus, different types of nodes have to provide a similar kind of data flow control, although adapted to the particular features of the node. In general, the data flow control have to be implemented such that a valid data signal, which is influenced by a consume signal, must not influence said consume signal, and a consume signal, which is influenced by a valid data signal, must not influence said valid data signal.

A simple way of achieving this is to select one direction of the two for all nodes in the machine. Either nodes may contain valid paths that depend on consume paths, or nodes may contain consume paths that depend on valid paths. This approach facilitates the automatic creation of Data Flow Machines in digital logic circuits without the possibility of creating combinatorial loops.

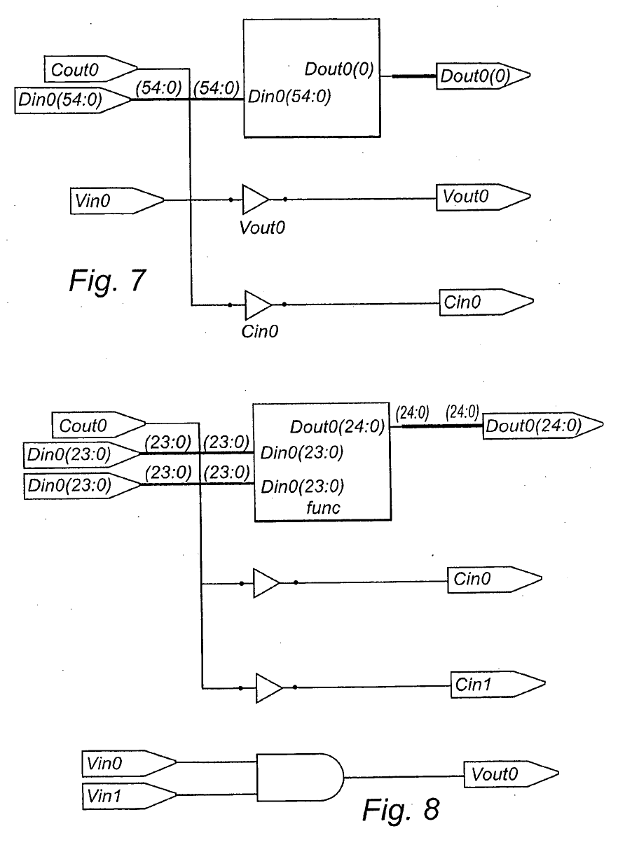

A specific example of the functioning of firing rules can be given through a node, as illustrated in FIG. 7, performing a function on one data input Din0 and giving one data output Dout0. It comprises a valid data input Vin0, a consume data input Cout0, a data valid output Vout0, and a consume data output Cin0 for data flow control. Here it should be noted the notation of the signals, where “in” refers to an interface to preceding node/s, and “out” refers to an interface to subsequent node/s. This notation will be used throughout the description and the accompanying drawings. It should be noted that all inputs are placed to the left and all outputs to the right in the figures, and not gathered according to the interfaces to the preceding and subsequent nodes. Thus Cout0 is an input from a subsequent node and Cin0 is an output to a preceding node, where preceding and subsequent should be interpreted according to the data flow.

Returning to the node illustrated by FIG. 7, the node can be described by:

Cin0<=Cout0;

vout0<=Vin0;

Dout0<=f(Din0);

Other examples are a node performing a function on a plurality of tokens, where FIG. 8 illustrates an example where the function is performed with two tokens as operands. The node can be described by:

Cin0<=Cout0;

Cin1<=Cout0;

. . .

Vout0 <=Vin0 and Vin1 and . . . ;

Dout0 <=f(Din0, Din1, Din2, . . . );

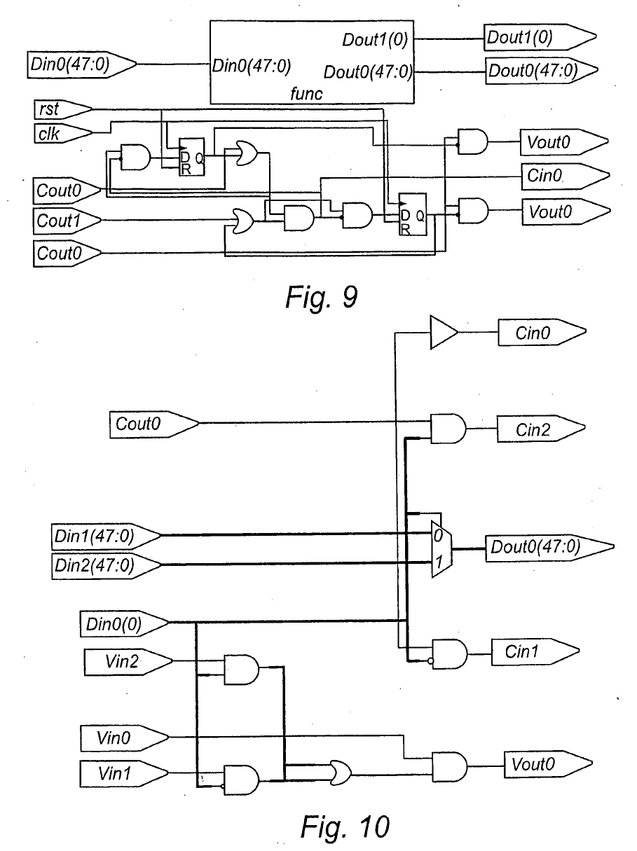

Another example is a node performing a function on a token which function gives a plurality of outputs, where FIG. 9 illustrates an example where the function gives two outputs. Further examples are a node performing a merge of a plurality of input tokens by moving one of the plurality of tokens to an output depending on a condition, where FIG. 10 illustrates an example of two input tokens, which can be described by:

Cin0<=Cout0;

Cin1<=Cout0 and Din0=0;

Cin2<=Cout0 and Din0=1;

Dout0<=Din1 when Din0=0 otherwise Din2;

Vout0<=Vin0 and ((Vin1 and Din0=0) or (Vin2 and Din0=1));

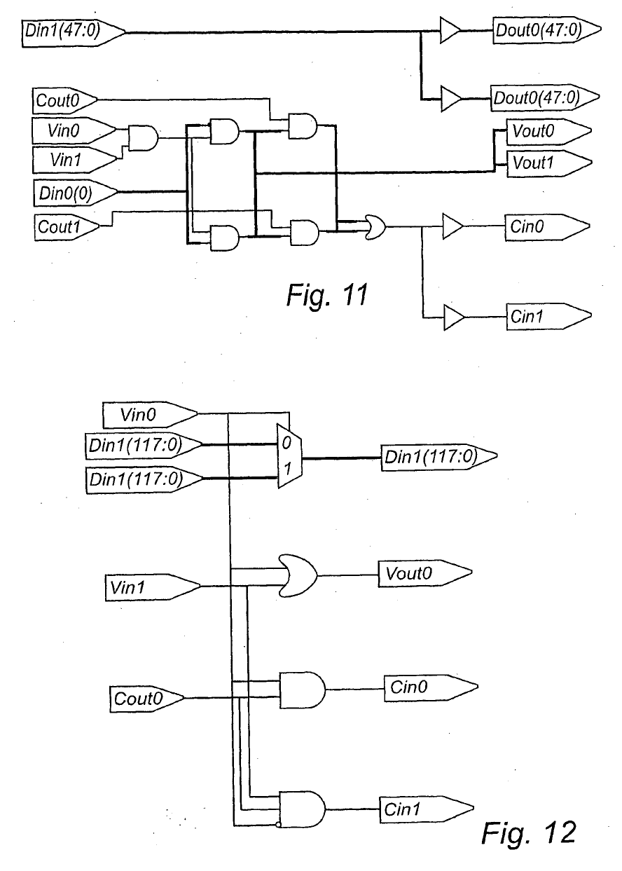

Another example is a node performing a switch where the node produces the input token on one of a plurality of outputs depending on a condition, where FIG. 11 illustrates an example of two outputs, which can be described by:
Cin0<=(Vin0 and Din0=0 and Cout0) or (Vin0 and Din0=1 and Cout1);
Cin1<=(Vin0 and Din0=0 and Cout0) or (Vin0 and Din0=1 and Cout1);
Dout0<=Din1;
Vout0<=Din0=0 and Vin0 and Vin1;
Dout1<=Din1;
Vout1<=Din0=1 and Vin0 and Vin1;

A further example is a node performing a prioritized merge of a plurality of input tokens by moving one of the plurality of tokens to an output depending on where data is present on the inputs, where the inputs are prioritized, where FIG. 12 illustrates an example of two inputs. The node can be described by:

Cin0<=Vin0 and Cout0;

Cin1<=not Vin0 and Vin1 and Cout0;

Dout0<=Din0 when Vin0 otherwise Din1; —select port 0 before port 1

Vout0<=Vin0 or Vin1;

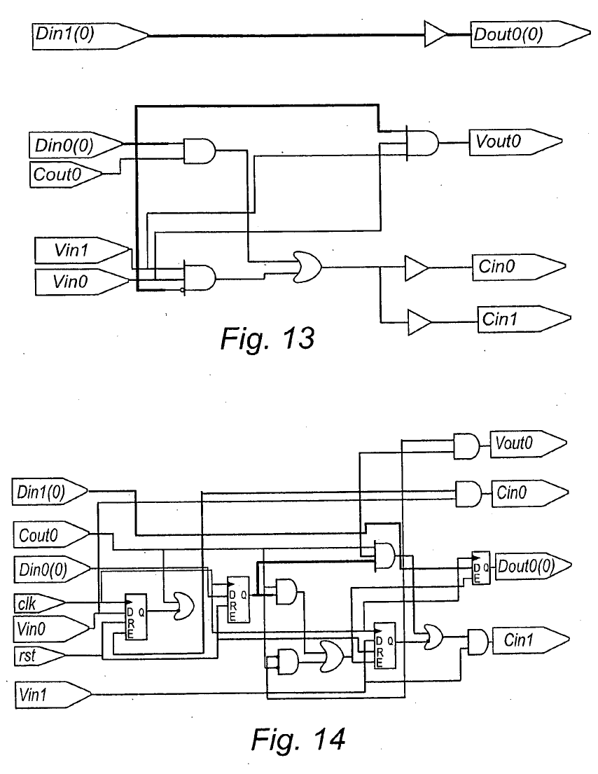

FIG. 13 illustrates a true gate, which passes through a token if a condition is true. The node can be described by:

Dout0<=Din1;

Vout0<=Vin0 and Vin1 and Din0=1;

Cin0<=(Din0=1 and Cout0) or (Din0=0 and Vin0 and Vin1);

Cin1<=(Din0=1 and Cout0) or (Din0=0 and Vin0 and Vin1);

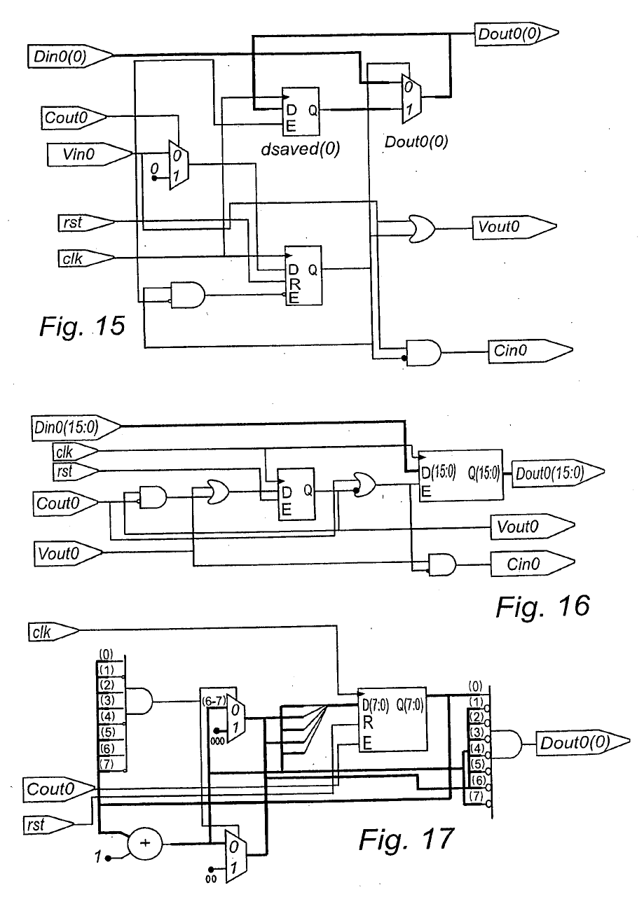

FIG. 14 illustrates a node consuming a value when true and performing a duplicate of it when false. In FIG. 14, the condition is that the condition input is false for duplicate, but a similar embodiment can be performed for other conditions. FIG. 15 illustrates a node performing a cutter function, which will be further described below. An important type of node is the buffer, which stores values before passing them on. The size, i.e. the length, of the buffer can be from one to a large number of storage steps. FIG. 16 illustrates a buffer node with length one. Buffers of greater size will be further provided with control logic for managing input and output. FIG. 17 illustrates a node performing a so called boolstream, i.e. a function that produces a number of false tokens, e.g. as many as a counter gives, and then a new true token, and then the sequence is repeated.

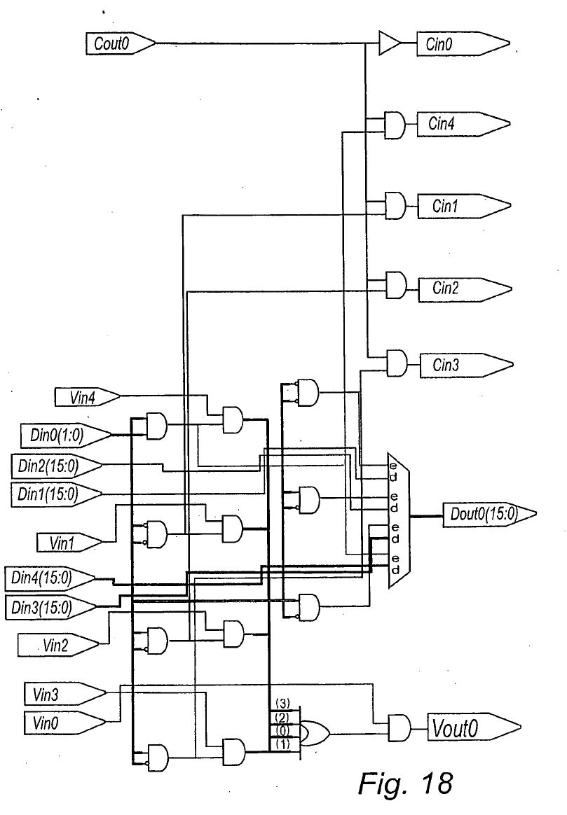

FIG. 18 illustrates a merge node for four values, which can be compared with the merge node for two values illustrated in FIG. 10, and can be described by:
Cin1<=Cout0 and Din0=0
Cin2<=Cout0 and Din0=1
Cin3<=Cout0 and Din0=2
Cin4<=Cout0 and Din0=3
Dout0<=Din1 when Din0=0 else
   Din2 when Din0=1 else
   Din3 when Din0=2 else
   Din4 when Din0=3;
Vout0<=((Din0=0 and Vin1) or
   (Din0=1 and Vin2) or
   (Din0=2 and Vin3) or
   (Din0=3 and Vin4)) and Vin0;
Cin0 <=Cout0;

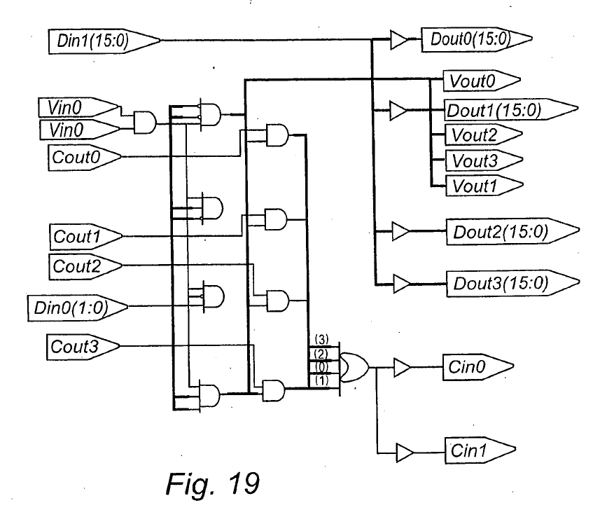

FIG. 19 illustrates a switch node for four values, which can be compared with the switch node for two values illustrated in FIG. 11. The node can be described by:
Dout0 <=Din1;
Dout1 <=Din1;
Dout2<=Din1;
Dout3<=Din1;
Vout0<=Vin0 and Vin1 and Din0=0;
Vout1 <=Vin0 and Vin1 and Din0=1;
Vout2<=Vin0 and Vin1 and Din0=2;
Vout3<=Vin0 and Vin1 and Din0=3;
Cin0 <=
   (Din0=0 and Cout0) or
   (Din0=1 and Cout1) or
   (Din0=2 and Cout2) or
   (Din0=3 and Cout3);
Cin1<=
   (Din0=0 and Cout0) or
   (Din0=1 and Cout1) or
   (Din0=2 and Cout2) or
   (Din0=3 and Cout3);

Another example of the functioning of firing rules can be given through a node comprising a so called false gate, i.e. an opposite to the true gate demonstrated above, which passes through a token if the condition is false, otherwise it removes the token. It comprises two data inputs and one data output. Thus, it comprises two valid data inputs, two consume inputs, one data valid output, and one consume output. The valid data output is formed by a logic of the two valid data inputs and the first data input. The data output is given the value of the second data input. The consume inputs are formed by logics of the first data input, the consume output, and the two valid data inputs. The function of the node can be described by:

Dout<=Din1;

Vout<=Vin0 and Vin1 and Din0=0;

Cin0<=(Din0=0 and Cout) or (Din0=1 and Vin0 and Vin1);

Cin1<=(Din0=0 and Cout) or (Din0=1 and Vin0 and Vin1);

Each node can thus be provided with additional signal sets for providing correct data at every time instant. The first additional sets carries “valid” signals which indicates that previous nodes have stable data at their outputs. Similarly, a node provides a “valid” signal to a subsequent node in the data path when the data at the output of the node is stable. By this procedure, each node is able to determine the status of the data at its inputs.

Moreover, second additional signal set carries a “consume” signal which indicates to a previous node whether the current node is prepared to receive any additional data at its inputs. Similarly, a node also receives a “consume” signal from a subsequent node in the data path. By the use of consume signals it is possible to temporarily stop the flow of data in a specific path. This is important in case a node at some time instances performs time-consuming data processing with indeterminate delay, such as loops or memory accesses. The use of a consume signal is merely one embodiment of the current invention. Several other signals could be used, depending on the protocol chosen. Examples include “stall”, “ready-to-receive”, “acknowledge” or “not-acknowledge”-signals, and signals based on pulses or transitions rather than a high or low signal. Other signaling schemes are also possible. The use of a “valid” signal makes it possible to represent the existence or non-existence of data on an arc. Thus not only synchronous data flow machines are possible to construct, but also static and dynamic data flow machines. The “valid” signal does not necessarily have to be implemented as a dedicated signal-line, it could be implemented in several other ways too, like choosing a special data value to represent a “null”-value. As for the consume signal, there are many other possible signaling schemes. For the sake of clarity, the rest of this document will only refer to consume and valid data signals. It is simple to extend the function of the invention to other signaling schemes.

With the existence of a dedicated consume signal line, it is possible to achieve higher efficiency. The consume signal makes it possible for a node to know that even if the arc below is full at the moment, it will be able to accept an output token at the next clock cycle. Without a dedicated consume signal line, the node has to wait until there space on the arc below before it can fire. That means that the entry to an arc will be empty at least every other cycle, thus loosing efficiency.

FIGS. 7 to 19 illustrate examples of the logic circuitry for producing the valid data and consume signals for a node. Generally, the firing rule is complex and has to be established in accordance with the function of the individual node.

In case of a complex data flow machine, consume lines may become very long compared to the signal propagation speed. This may result in that the consume signals do not reach every node in the path that needs to be stalled, with loss of data as result (i.e. data which have not yet been processed are written over by new data).

This can be solved in a number of ways. The consume signal propagation path can be very carefully balanced to ensure that it reaches all target registers in time. Alternatively a fifo-buffer can be placed after a stoppable block, completely avoiding the use of a consume signal within the block. Instead the fifo is used to collect the pipeline data as it comes out of the pipeline. The former solution is very difficult and time consuming to implement for large pipelined blocks. The latter requires large buffers that are capable of holding the entire set of data that can potentially exist within the block.

A better way to combat this limited signal propagation speed is by a feature called a “cutter” illustrated in FIG. 17. A cutter is basically a register which receives the consume line from a subsequent node and delays it for one cycle. This cuts the combinatorial length of the consume signal at that point. When the cutter receives a valid consume signal, it buffers data from the previous node during one processing cycle and at the same time delays the consume signal by the same amount. By delaying the consume signal and buffering the input data, it is ensured that no data are lost even when very long consume lines are used.

The cutter can greatly simplify the implementation of data loops, especially pipelined data loops. In this case, many variations of the protocol for controlling the flow of data will call for the consume signal to take the same path as the data through the loop, often in reverse. This will create a combinatorial loop for the consume signal. By placing a cutter within the loop, such a combinatorial loop can be avoided, enabling many protocols that would otherwise be hard or impossible to implement.

Finally, a cutter is transparent from the point of view of data propagation in the data flow machine. This implies that cutters can be added where needed in an automated fashion.

An alternative to a dedicated consume line is that the node that is to produce data checks if its data output is non-valid. Thus, no dedicated consume bit is needed, which solves the problem with long consume signal lines. However, a node then have to wait until data on a data output arc have been consumed by the subsequent node, which implies that firing is slowed down. However, this is feasible in areas of the data flow machine not demanding high throughput.

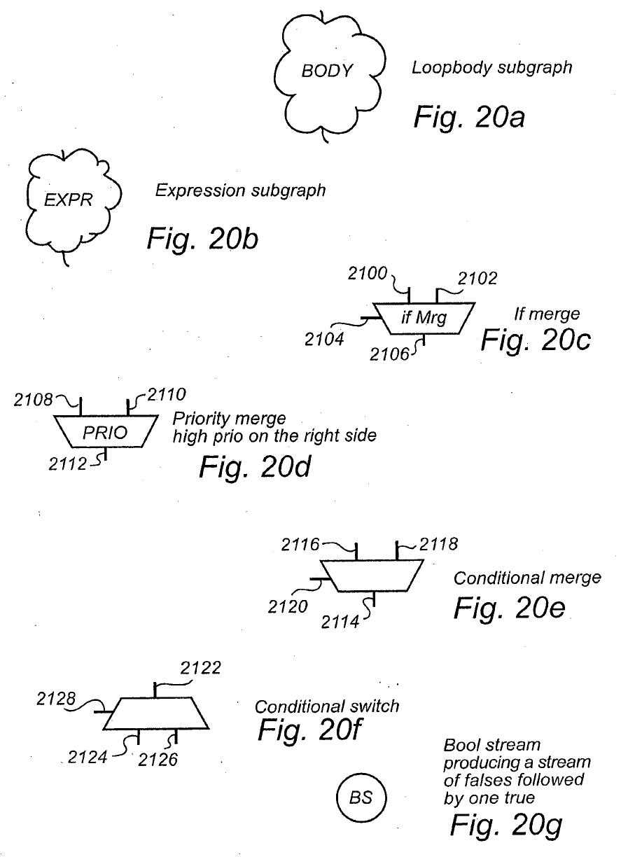

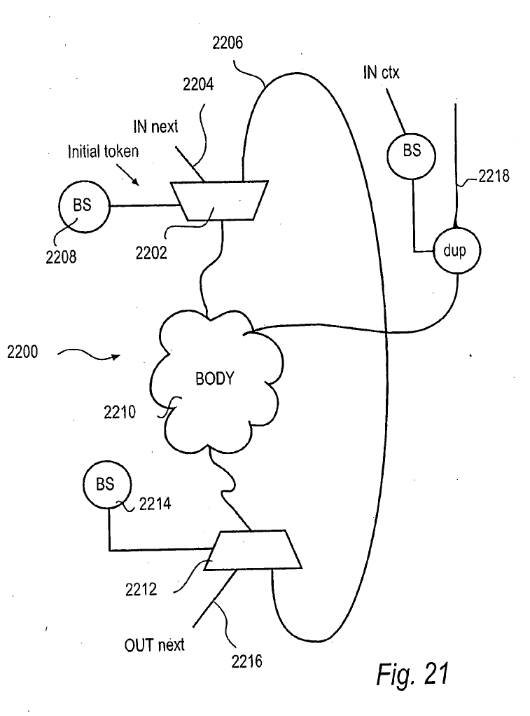

FIGS. 20a to 20g illustrates examples of parts for illustrating the embodiments of the present invention illustrated in the drawings. FIG. 20a illustrates an element referring to a loop subgraph, i.e. a function to be performed in the data flow machine to process values. FIG. 20b illustrates an expression subgraph, i.e. an element of the data flow machine producing expressions for e.g. keeping track on iterations, conditions for loops, etc. FIG. 20c illustrates a merge node, here an if-merge, i.e. a node merging values 2100, 2102 depending on a value 2104 to produce a result value 2106. FIG. 1d illustrates a priority merge node, i.e. a node merging values 2108, 2110 to produce result value 2112. The result value 2112 is the one of values 2108, 2110 being present. If both values 2108, 2110 are present, right value 2110 is prioritized. FIG. 20e illustrates a conditional merge node producing a result value 2114 from values 2116, 2118 depending on condition 2120. FIG. 20f illustrates a conditional switch producing value 122 either on 2124 or 2126 depending on condition 2128. FIG. 20g illustrates a boolstream node producing a stream of a predetermined number of false conditions followed by a true condition, which is then repeated.

FIG. 21 illustrates a for-loop 2200 comprising a conditional merge node 2202 getting values at an input 2204 or a loop 2206. The number of iterations is determined by a boolstream 208 causing the merge node 2202 to take a value from the input and then loop it through a body 2210 as many times as the boolstream 2208 is arranged to produce false conditions before next true value. This is possible since a switch 2212 controlled by a similar boolstream 2214 switches the output from the body 2210 to the loop 2206 the same number of times, and then to an output 2216. Here, a context value 2218, which is a value that is constant during the iterations, is duplicated in a duplicator the same number of times determined by a boolstream, and then provided to the body 2210.

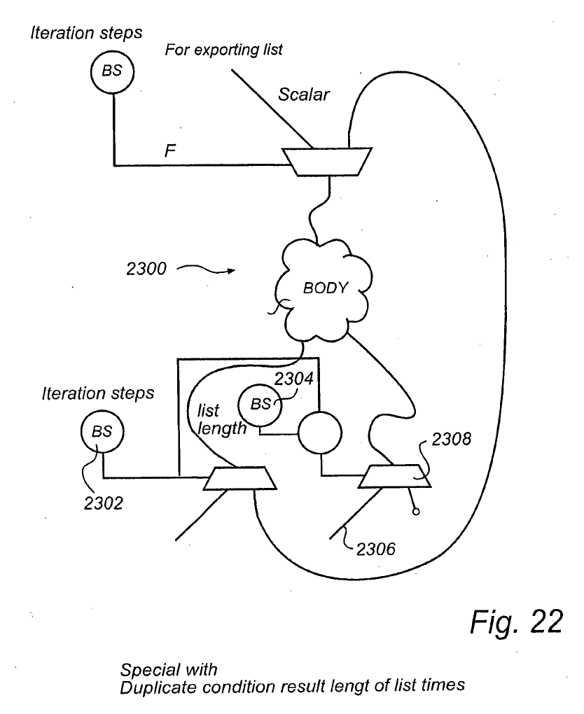

FIG. 22 illustrates a for-loop 2300 similar to the one illustrated in FIG. 21. The for-loop 2300 provides a feature of exporting a list during iterations. This is enabled by a switch 2300 controlled by conditional values from a first boolstream 2302 determining the number of iterations, which is duplicated a predetermined number of times determined by a second boolstream 2304 determining the length of the list. The switch 2300 outputs the list on the output 2306 as determined by the first and second boolstreams 2302, 2304, while values that is not to be in the list will be switched to a gate (not shown) that erases the values.

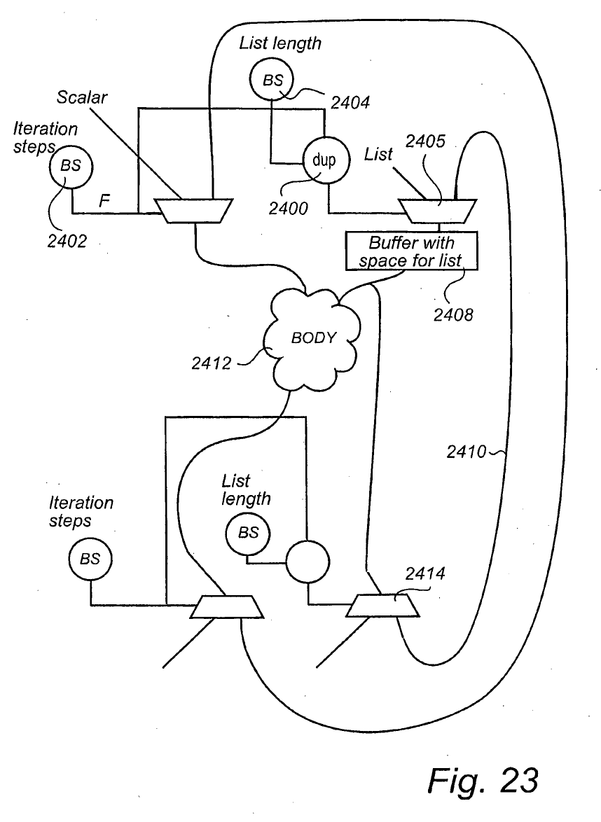

FIG. 23 illustrates a for-loop that applies a similar technique to import a list, using a duplicator 2400 and two boolstreams 2402, 2404. The first boolstream 2402 determines the number of iterations and the second boolstream 2404 determines the list length. The duplicated conditions from the first boolstream, i.e. to be as many true conditions as the list length then followed by false conditions until the iterations are ready, control a merge node 2406 to read the entire list and store it in a buffer 2408 with space for the entire list. The list will then be circulated in an inner loop for each iteration, and at the same time be provided to a body 2412. For being able to empty the list, there is provided a switch 2414 controlled for agreeing with the number of iterations and the list length with the technique as described above.

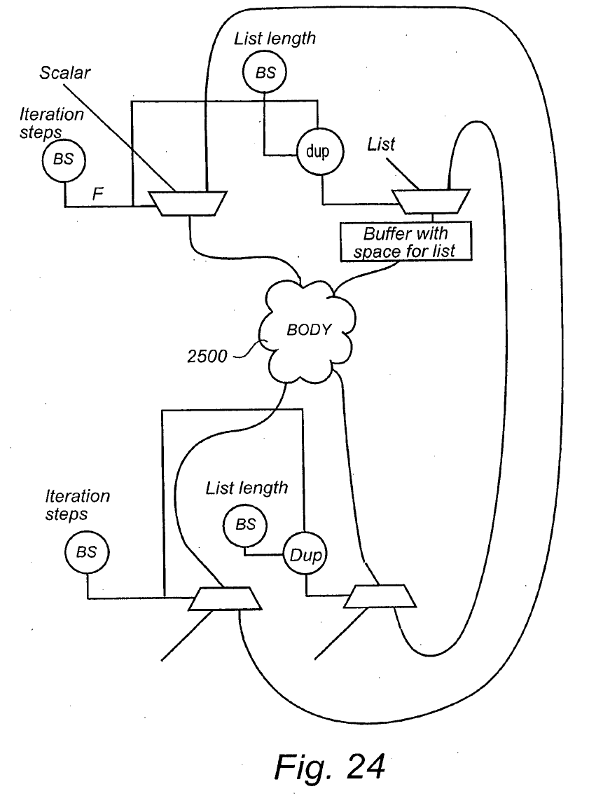

FIG. 24 illustrates a for-loop similar to the one illustrated in FIG. 23, but circulating the list through a body 2500. This enables the list to be loop-dependent.

In general, according to the invention, two types of loops may be implemented: 1) Loops with loop-dependent variables wherein a variable is dependent upon itself in each iteration, and 2) Loops without loop-dependent variables (besides a counter which keeps track of the actual round of the loop); throughout this text, loops of this kind are called “foreach” loops.

Loops with loop-dependent variables may be divided into two sub-groups: 1a) Loops in which the number of rounds in the loop is calculated inside the loop, i.e. a condition, which determines whether or not the loop will continue or not, is dependent on a loop-dependent variable; throughout this text, loops of this kind are called “while”-loops, and 1b) Loops which go round a predetermined number of times during the execution of a program; throughout this text, loops of this kind are called “for” loops.

A “next variable (NXT)” is a variable which has a loop-dependency. It calculates its “next” value for every iteration (possibly through other intermediate calculations). The “for” and “while” loops have NXT, while “foreach” does not.

A “context variable (CTX)” is a variable which does not change during the execution of the loop. It gets its value from the loop (the context) and that value does not change.

A “re-entrant” loop is a data-dependent loop (for/while) in which it is possible to perform simultaneous execution of a plurality of iterations through pipelining. A “while” loop which is “re-entrant” need to be tagged, i.e. an ID needs to be assigned to each value in the pipeline. This makes it possible to sort the values after the loop is finished. Without tagging a value, which entered the loop after another value, may leave the loop prior to the other value if it goes round the loop fewer number of times. This result in a non-deterministic behaviour.

“Export” of a value implies that a non-loop-dependent variable is returned from the loop. Import of a value implies that the value is a “CTX”-value.

A “list” is a series of tokens which are treated as a group of values (a list of values) which are streamed after each other.

A “vector” is a completely broadparallel design. It is a collection of values which all exist at the same time in the data flow machine and which are all accessible. Lists and vectors are called “collections”.

When iterating over collections, the number of iterations equals the number of elements in the collections which are iterated, and one element will be read each iteration from the collections that are iterated.

To iterate over a list or vector implies for lists that one value at a time is fed into the loop. For a vector this implies that the same number of loop-bodies are created as there are elements in the vector, and each body simultaneously handles each element in the vector.

It is possible to iterate over a collection, to import a collection from CTX or to make loop-dependent changes of a collection in NXT.

A “foreach” always returns a collection (no data-dependencies may occur between iterations, so it may only operate on one element at the time in the collection).

A “for” may return either a value (a sum) or a collection of the value (e.g. the values of the current sum during an addition).

It is possible to have many variables in CTX, NTX and many collections which are iterated simultaneously.

The basic mechanism of a dataflow machine is that a node will perform its operation when it has all its input, consuming its input and producing the relevant output (if any). The node will not perform any operation until it has sufficient inputs. Any input that arrives ahead of time simply waits on the edge before the node until sufficient input for the node's operation has arrived. If an output edge of a node is occupied, it will delay activation until the edge is freed. This feature is taken advantage of in the for-loops with initial tokens (values) on some of the edges.

The basics of the loops:
Foreach will iterate across the source collection, performing the loop body on each element of the source collection independently of all other iterations.
For will iterate across a source collection, performing the loop body on each element and having a loop carried dependency in a loop dependent variable(s)
While will iterate as long as a condition is true, performing the loop body once per iteration of the loop dependent variable(s).

A normal loop with dependencies only takes in one set of values at a time. The set of values is calculated and when the result is produced, the loop is in a state that allows a new set of values to be input.

As an example, a basic for-loop is considered:

i = 0;
a = for(e in <1..10>)
{
i = i + 1;
} return i;

After execution, a will have the value 10.

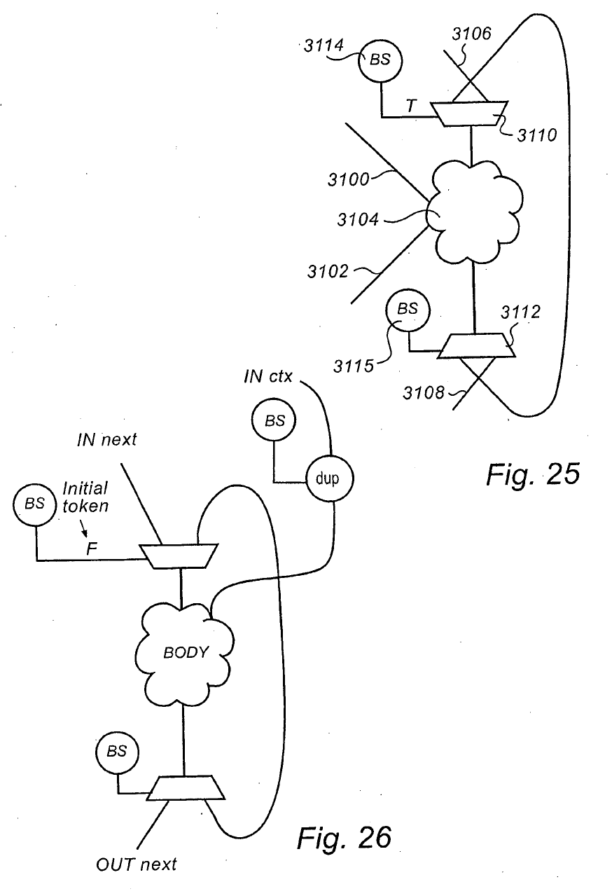

This loop is depicted in FIG. 25, though the input 3100 and output 3102 that go directly to/from the loop body 3104 are not used. That input 3100 and output 3102 is the collection input/output to the for-loop. The center-top input 3106 of the picture is the next-input. In the example, the initial value of i (in this case 0) enters the loop here. The center-bottom output 3108 of the loop is the next-output. The result of this loop comes out here. The cloud in the center illustrating the loop body 3104 takes the input from the merge 3110 and adds 1 to it, sending its result to the switch 3112. The two boolstreams 3114, 3115 will each produce 10 false values, followed by a true value.

As another example, a for-loop with ctx input is considered:

i = 0;
b = 10;
a = for(e in <1..10>)
{
i = i + b;
} return i;

After execution, a will have the value 100.

This loop is depicted in FIG. 26. The value of b will be duplicated as many times as the loop iterates, added to i in each iteration. Apart from that it is similar to the basic loop discussed with reference to FIG. 25.

As another example, a for-loop iterating from a list-collection is considered:

i = 0;
a = for(e in <1..10>)
{
i = i + e;
} return i;

After execution, a will have the value 55.

This loop is illustrated in FIG. 25, this time the input 3100 that goes directly to the loop body 3104 is used. The values of the list being iterated across (<1 . . . 10>) are sent in on that input 3100, one value at a time. That value is added to the value from the merge 3110 in each iteration, and the result is sent to the switch 3112. Apart from that, it is similar to the basic for-loop.

As another example, a for-loop iterating to a list-collection is considered:

i = 0;
a = for(e in <1..10>)
{
i = i + e;
} return all i;

After execution, a will be a collection containing the running total of the sums of <1 . . . 10>, i.e. the values <1, 3, 6, 10, 15, 21, 28, 36, 45, 55>

This loop is depicted in FIG. 25, however, now the output 3102 directly from the cloud is used. It is a copy of each value sent to the switch node 3112.

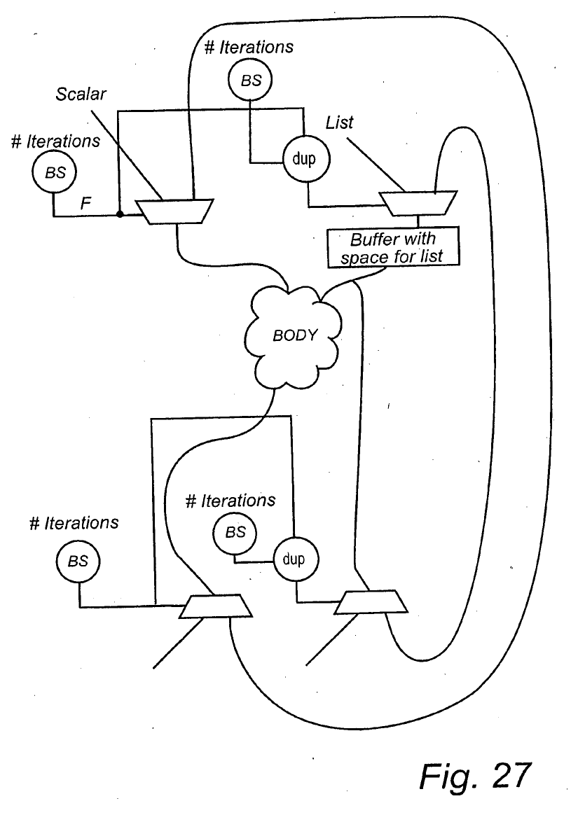

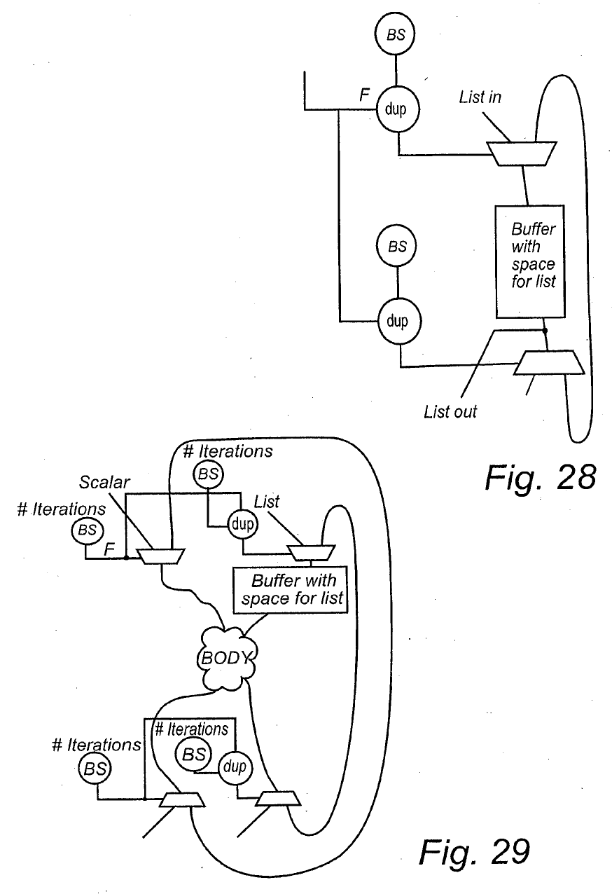

FIG. 27 depicts a loop that is similar to the loop illustrated in FIG. 26, but now the loop-invariant input is a list instead of a single value (presumably the imported list is used in the loop body). The list is copied as many times as the loop iterates. As an alternative, a list-dup-node like the one depicted in FIG. 28 can be used instead of the inner loop depicted in FIG. 27.

FIG. 29 illustrates a similar loop as FIG. 27, but here the imported list is no longer loop-invariant, but is instead changed in each iteration of the loop. Here, the loop body provides room for the list.

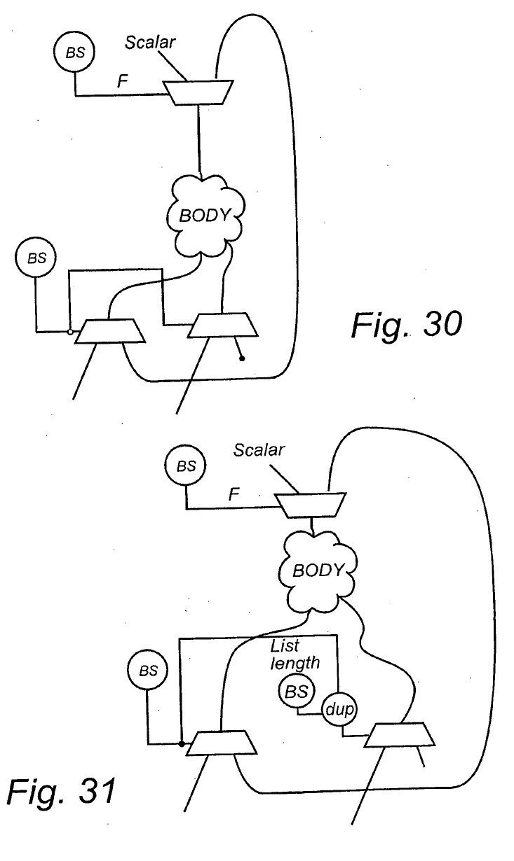

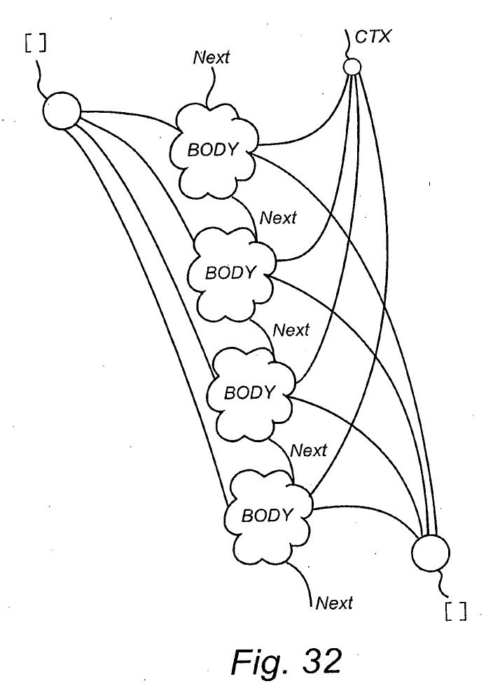

FIG. 30 illustrates a similar loop as FIG. 26, but with an added loop invariant return value. The return value can be a list if the condition input to the output-switch is duplicated by a dup-node as many times as the length of the result list, as is shown in FIG. 31.

FIG. 32 illustrates a fully unrolled loop, also called vector-loop, and in this case it is a for-loop, so each body passes on the loop dependent result to the next loop body. The list-input is now a number of vector inputs (one for each element of the vector). The ctx has one copy of its value distributed to each loop body.

In contrast to the normal loop with dependencies, that can only operate on one set of inputs at a time, a re-entrant loop with dependencies can take in a new set of independent inputs immediately after the first one, and can insert new input sets as soon as there is space in the loop. This makes the loop pipelined.

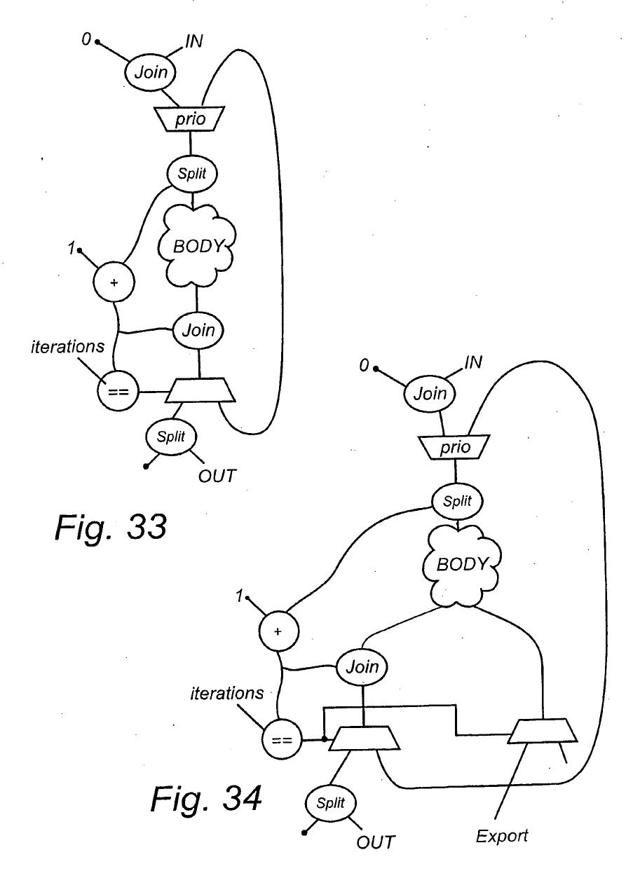

The for-loop can be made re-entrant, as is illustrated in FIG. 33. In this case, a prio-merge replaces the input-merge that the for-loop illustrated e.g. in FIG. 25 has. The join and split-nodes (see below) are there to ensure that the input values and the internal loop-counter enter the loop simultaneously. The effect of the join and split nodes could have been achieved by multiple linked prio-merge nodes.

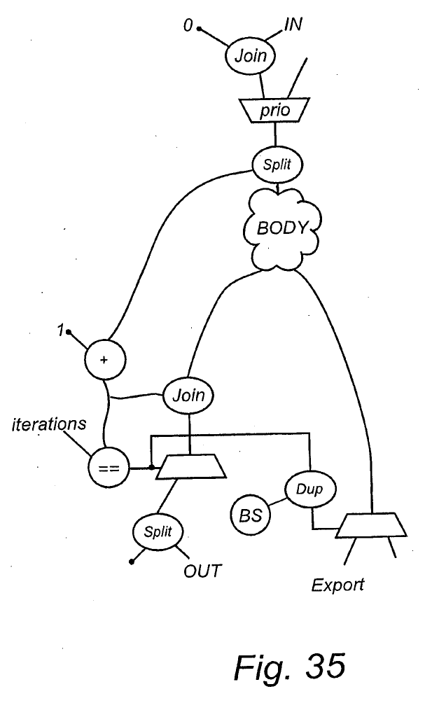

FIGS. 34 and 35 show a re-entrant for-loop with a scalar and a list context output, respectively.

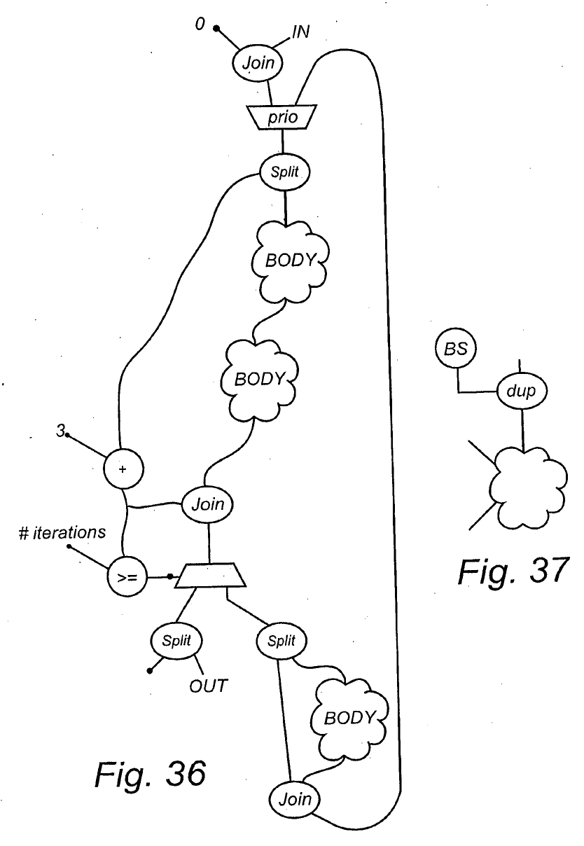

FIG. 36 shows a re-entrant for-loop that is partially unrolled, i.e. there are multiple copies of the body, but not as many as the number of iterations of the loop. In this case, the loop exit has to be positioned after the loop body numbered the number of iterations modulo the number of copies of the loop body. This takes advantage of the fact that the for-loop iterates a fixed number of iterations (as many iterations as there are elements in the input collection).

As another example, a basic foreach loop is considered:

a foreach(e in <1 . . . 10>)e*e;

a will be a collection of the squares from 1 to 10 (i.e. <1, 4, 9, 16, 25, 36, 49, 64, 81, 100>).

The foreach loop does not permit any loop carried dependencies. The basic form looks like the for-loop illustrated in FIG. 25, but without the next-input and output of the switch/merge. I.e. it is simply a loop-body cloud with a simple input and a simple output. The iteration collection is input at the top and output at the bottom. FIG. 37 shows a foreach-loop with a loop-invariant context input.

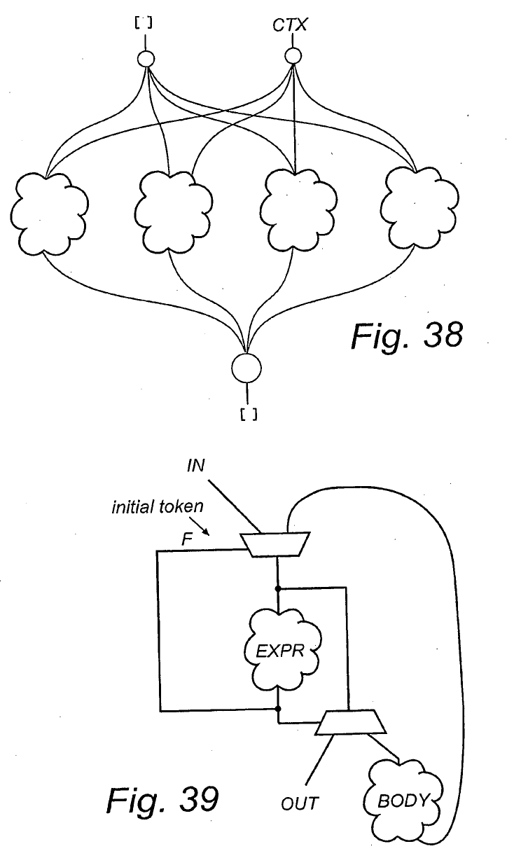

FIG. 38 shows a foreach loop iterating across a vector instead of a list, i.e. fully unrolled, like the for-loop in FIG. 32. Note that there is no loop dependent value passed between the bodies. FIG. 38 also shows a context input distributed to the various bodies.

As another example, a basic while loop is considered:

i = x;
a = while(i < c)
{
i = f(i);
} return i;

FIG. 39 illustrates a while-loop. The while loop does not iterate across a collection. Instead it iterates until a condition is fulfilled. This condition might be different for each invocation of the while-loop. This means that there is a loop dependency, since the condition does not change otherwise (causing an infinite loop). Since the while-loop iterates until its expression evaluates to false, it can not use fixed-length boolstreams to control the input-merge and output-switch. Instead, the result of the condition is used. Apart from that, it is very similar to a for-loop that does not use the collection input/output, as has been demonstrated above.

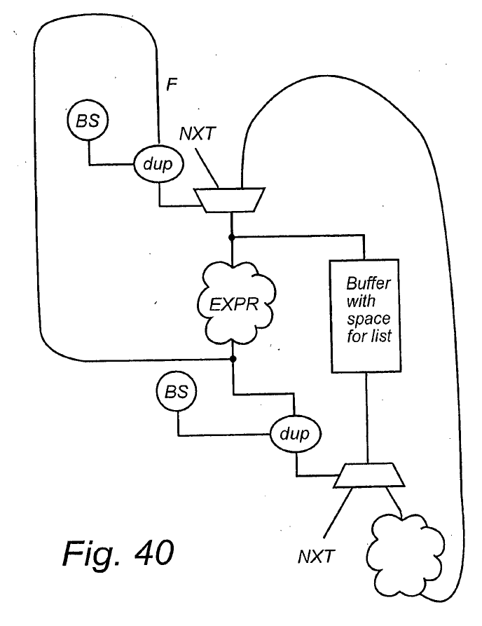

FIG. 40 shows a while-loop where the loop dependency is a collection, just like the for-loop in FIG. 29.

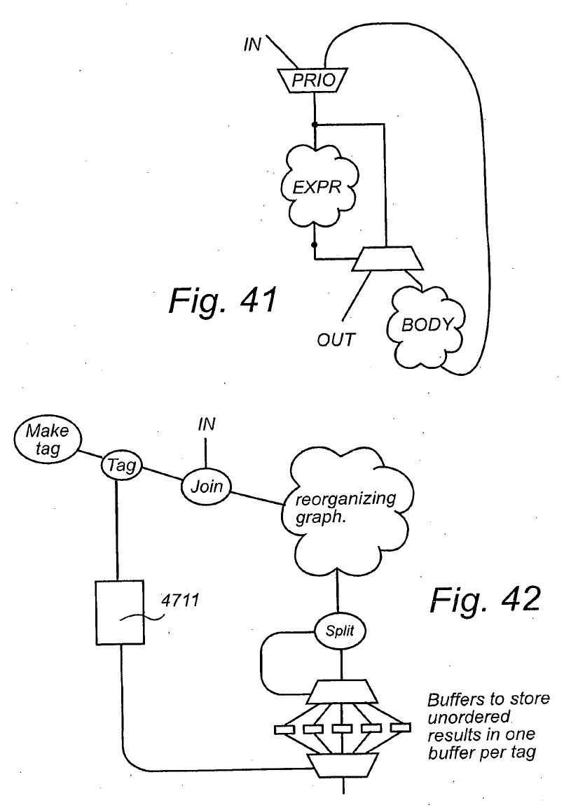

FIG. 41 shows a basic re-entrant while loop. However, this loop is non-deterministic. The while-loop will iterate a different number of times on each invocation. That means that for each set of inputs, that set may iterate a different number of turns than a following set. Because of this, a later input set might exit the loop before an earlier input set that iterates longer. This may cause mis-matches in other parts of the machine.

To avoid the problem of the non-determinate while, a tagging system is employed, as shown in FIG. 42. This associates each input set with a tag, usually a simple number. After the data has exited the loop, the results can be sorted according to tag and allowed to exit in an orderly fashion. Such a tagging scheme allows a local dynamic dataflow machine to exist in the context of a fully static Dennis-dataflow machine. On the outside of the tagging system, the unit behaves like a static dataflow machine, but inside it behaves like a dynamic dataflow machine. Preferably, the reorganization graph is able to associate a tag to the data and keep the tag with the result, and the tag buffer 4711 size is equal to the number of tags.

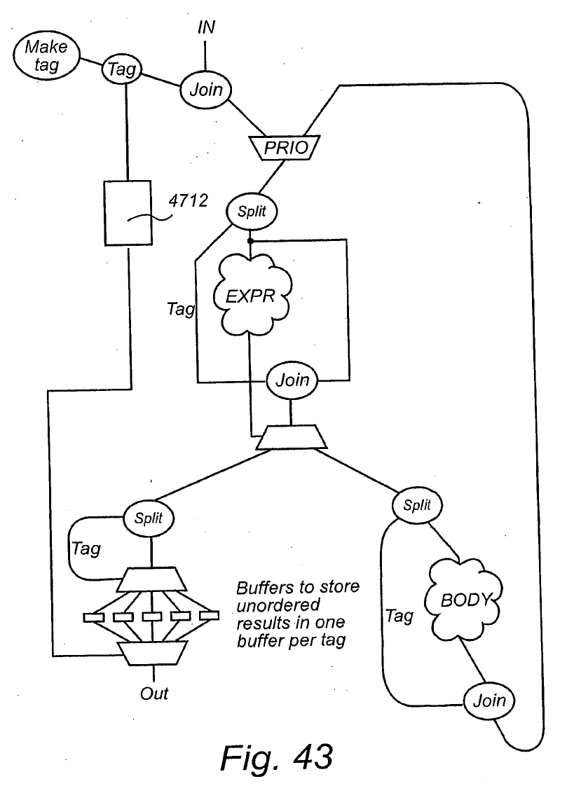

FIG. 43 shows an example of a re-entrant while with the tagging mechanism added. Here, a tag number is 0, 1, 2, 3 . . . and the tag buffer 4712 size is equal to the number of tags.

Picture “dowhile” shows a data flow machine that performs the do-while, also known as repeat-until loop. It is similar to the while-loop, but always executes the body once, before evaluating the condition. “dowhile_reent” shows a re-entrant version of the do-while loop, without the tagging system. Since the do-while iterates a different number of times for each invocation, just like the while-loop, the tagging system should be added to the re-entrant do-while for correct execution.

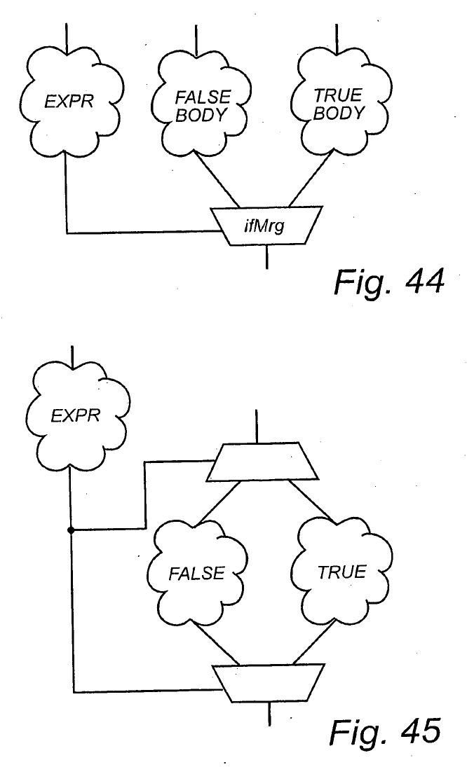

FIG. 44 shows a speculative if-operation. The if-merge node will wait until it has data on all its three inputs (condition, true-branch and false-branch). It will then choose the value from the branch indicated by the condition input. This design of an if-functionality is more efficient than a switch-merge if, depicted in FIG. 45.

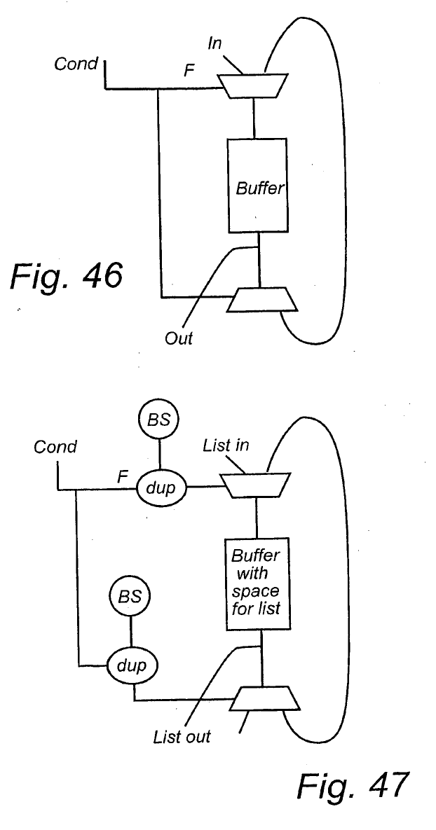

FIG. 46 shows the dup-node as decompositioned into switch and merge. FIG. 47 shows a similar dup-node for list-dup.

In brief, features of the different loop types can be described by:
The foreach-loop has no loop dependencies and thus has no loop dependent variables
The for-loop requires at least one loop dependent variable
The while- and do-while loops have a run-time calculated expression determining the number of iterations
The while loop may iterate zero times, the do-while loop always iterates at least once
The foreach loop is always pipelineable
The for-loop and while-loop can be made re-entrant
A re-entrant loop that iterates a a different number of iterations per invocation must have a tagging and sorting system associated to ensure the correct exit-order of values. This means the while re-entrant and do-while re-entrant need tagging.
A re-entrant while will execute the conditional expression one time more than the loop body. This means that the loop body will be empty at least one iteration. A re-entrant do-while loop can have an if-expression around it containing the same conditional expression as the loop. In this case, the loop body may be always full, and perform the same operation as a while-loop

In brief, inputs and outputs of the loops can be described by:
Loop dependent variables enter a loop on the nxt-in input, they exit the loop on the next-out exit
Loop invariant variables (variables defined outside the loop, thus staying the same throughout the loop) enter the loop on ctx-in (or import)
Loop invariant variables, and variables calculated indirectly from loop dependent variables exit the loop on ctx-out (or export)
Loops iterating across a collection enter the collection on “collection in”
Loops returning their results to a collection return the result on “collection out”

In brief, data types for the loops can be described by:
Loops may iterate on scalars
Loops iterating across a collection may iterate across a list or a vector
Iterating across a list means that one element at a time is taken from the collection
Iterating across a vector means that all elements of the collection are iterated on simultaneously

The various loops has been described with reference to the appended figures. As an overview, a table below indicates references to the figures where the various types of loops has been depicted. A legend for the table is as follows, where number of respective figures are indicated after each letter in round brackets:

f: for-loop

rf: re-entrant for-loop

w: while-loop

rw: re-entrant while-loop

e: foreach

TABLE

| | Scalar | List | Vector |
|---|---|---|---|
| Next Input | f(25, 26) | f(29) | Like |
| | w(39) | w(40) | scalar |
| | rf(33) | rf(not | but |
| | rw(41, 42, 43) | shown) | replicated |
| | | rw(not | |
| | | shown) | |
| Next Output | f(25, 26) | f(29, 31) | Like |
| | w(39) | w(40) | scalar |
| | rf(33) | | but |
| | rw(41, 42, 43) | | replicated |
| Import Ctx | f(25, 26) | f(27) | Like |
| | w(39) | w(40) | scalar |
| | rf(33) | rf(not | but |
| | rw(41, 42, 43) | shown) | replicated |
| | e(37) | rw(not | |
| | | shown) | |
| | | e(28) | |
| Export | f(30) | f(31) | Like |
| Ctx/temp | rf(34) | rf(35) | scalar |
| | | | but |
| | | | replicated |
| Over/From | None | f(25) | rf(32) |
| collection | | e(37) | e(38) |
| To Collection | None | f(25) | rf(32) |
| | | e(37) | e(38) |

Further, the following comments illustrate the features of the loops:
The for-loop over a vector is always re-entrant, since it is fully pipelined. This means that there is no loop any longer, only as many bodies placed after each other as the number of iterations the loop should have iterated. Such a straight line of operations is obviously pipelineable.
The join-node juxtapositions several values so that they can go through a node as one. The split node separates previously joined variables into their original individual values, in the same left-to-right order as they were joined in.

A re-entrant loop is usually done with a prio-merge. The for loop can be made re-entrant by using as many initial false tokens as there are pipeline positions within the loop, and duplicating the selection value an equal number of times.

Nodes can often be decompositioned into smaller parts. For example, the switch node can be decompositioned into gate-nodes. A gate node has one condition input and one data input. It has a single data output. A value on the input will be copied to the output if the condition input has a true value. If the condition input has a false value, the input will only be consumed, producing no output. A false-gate is exactly the same, but passing on the value when a false condition is received and consuming the value when a true-condition is received. Thus, a switch-node can be constructed with gate nodes.

A True-gate and False-gate both take the switch input and each have their own output (corresponding to the two outputs of the switch). The condition input to the switch is connected to the two gates. The total will behave as a switch.

Nodes can also be compositioned into larger nodes. For example the merges and switches around a for-loop can be compositioned into a “for-loop” node. Sometimes a compositioned node can be implemented more efficiently than the collection of individual nodes.

The invention has mainly been described above with reference to a few embodiments. However, as is readily appreciated by a person skilled in the art, other embodiments than the ones disclosed above are equally possible within the scope of the invention, as defined by the appended patent claims.

1. An apparatus for generating digital control parameters for implementing a Data Flow Machine in a digital logic circuitry comprising functional nodes with at least one input or at least one output and connections between said functional nodes, wherein said digital logic circuitry comprises a first path streamed by successive tokens and a second path streamed by said tokens, comprising a determinator arranged to determine necessary relative throughput for data flow to said paths; an assigner of buffers arranged to assign buffers to one of said paths to balance throughput of said paths; a remover of assigned buffers arranged to remove assigned buffers until said necessary relative throughput is obtained with minimized number of buffers; and a digital control parameters generator arranged to implement said digital logic circuitry comprising said minimized number of buffers.

2. The apparatus according to claim 1, wherein said first and second paths are parallel.

3. The apparatus according to claim 1, wherein said removal of assigned buffers is performed with regard to available space also for other parts of said implementation of said digital logic circuitry, relative throughput of said paths, and relative throughput of the rest of said implementation of said digital logic circuitry.

4. The apparatus according to claim 1, wherein at least one of said paths comprises at least two functional nodes wherein a first of said functional nodes has a first relative throughput and a second of said nodes has a second relative throughput, wherein said second relative throughput is adapted to be equal to said first relative throughput.

5. The apparatus according to claim 1, wherein said first and second paths are in series.

6. The apparatus according to claim 1, wherein said digital control parameters control an FPGA to implement said digital logic circuitry.

7. The apparatus according to claim 1, wherein said Data Flow Machine is generated from highlevel source code specifications.

8. The apparatus according to claim 1, wherein said digital control parameters control an Application Specific Integrated Circuit (ASIC) or a chip, or any combination thereof, to implement said digital logic circuitry.

9. A method of generating digital control parameters for implementing a Data Flow Machine in a digital logic circuitry comprising functional nodes with at least one input or at least one output and connections indicating interconnections between said functional nodes, wherein said digital logic circuitry comprises a first path streamed by successive tokens, and a second path streamed by said tokens, comprising determining a necessary relative throughput for data flow to said paths; assigning buffers to one of said paths to balance throughput of said paths; removing assigned buffers until said necessary relative throughput is obtained with minimized number of buffers; and generating digital control parameters for implementing said digital logic circuitry comprising said minimized number of buffers.

10. The method according to claim 9, wherein said removing is performed with regard to available space also for other parts of said implementation of said digital logic circuitry, relative throughput for said paths, and relative throughput for the rest of said implementation of said digital logic circuitry.

11. The method according to claim 9, wherein said at least one of said paths comprises at least two functional nodes wherein a first of said functional nodes has a first relative throughput and a second of said nodes has a second relative throughput, further comprising adapting said second relative throughput to be equal to said first relative throughput.

12. The method according to claim 9, comprising implementing said digital logic circuitry by means of an FPGA.

13. The method according to claim 9, further comprising generating said Data Flow Machine from high-level source code specifications.

14. The method according to claim 9, comprising implementing said digital logic circuitry by means of an Application Specific Integrated Circuit (ASIC) or a chip, or any combination thereof.

15. A computer program product comprising program code arranged to perform the method according to claim 9 when downloaded to and executed by a computer.

16. A digital logic circuitry comprising functional nodes with at least one input or at least one output and connections between said functional nodes implementing a Data Flow Machine, a first path capable of receiving a stream of successive tokens, and a second path capable of receiving a stream of said tokens, said second path comprising a minimized number of added buffers.

17. The circuitry according to claim 16, wherein said first and second paths are parallel.

18. The circuitry according to claim 16, wherein said minimization of assigned buffers is performed with regard to available space also for other parts of said implementation of said digital logic circuitry, relative throughput of said paths, and relative throughput of the rest of said implementation of said digital logic circuitry.

19. The circuitry according to claim 16, wherein at least one of said paths comprises at least two functional nodes wherein a first of said functional nodes has a first relative throughput and a second of said nodes has a second relative throughput, wherein said second relative throughput is adapted to be equal to said first relative throughput.

20. The circuitry according to claim 16, wherein said first and second paths are in series.

21. The circuitry according to claim 16, implemented by means of an FPGA.

22. The circuitry according to claim 16, wherein said nodes and connections implementing the Data Flow Machine is generated from high-level source code specifications.

23. The circuitry according to claim 16, implemented by means of an Application Specific Integrated Circuit (ASIC) or a chip, or any combination thereof.

24-110. (canceled)
